(19) United States
(12) Patent Application Publication
(10) Pub. No.: US 2009/0105065 A1
(43) Pub. Date: Apr. 23, 2009

(54) LIGHT EMITTING DEVICE WITH A CERAMIC GARNET MATERIAL

(75) Inventors: Hans-Helmut Bechtel, Roetgen (DE); Peter Schmidt, Aachen (DE); Wolfgang Busselt, Roetgen (DE); Baby-Seriyati Schreinemacher, Eynatten (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/293,304

(22) PCT Filed: Mar. 13, 2007
(86) PCT No.: PCT/IB2007/050837

§ 371 Date: Sep. 17, 2008

(30) Foreign Application Priority Data
Mar. 23, 2006 (EP) 06111579.6

(51) Int. Cl. C04B 35/50; C04B 35/18

(52) U.S. Cl. 501/152; 501/153

(57) ABSTRACT

The invention relates to a light emitting device, especially a LED comprising a ceramic garnet material.

The present invention is directed to light emitting devices, especially to the field of LEDs.

Phosphors comprising silicates, phosphates (for example, apatite) and aluminates as host materials, with transition metals or rare earth metals added as activating materials to the host materials, are widely known. As blue LEDs, in particular, have become practical in recent years, the development of white light sources utilizing such blue LEDs is being energetically pursued. As white LEDs are expected to have lower power consumption and longer usable lives than existing white light sources, development is progressing towards their applications in backlights of liquid crystal panels, indoor and outdoor lighting fixtures, backlights of automobile panels, automotive frontlights and signaling light sources, light sources in projection devices and the like.

However, in current LEDs there is the problem, that the lighting properties of the LED, especially the “color point” for low correlated color temperatures cannot be easily reached and adjusted without using a sophisticated technique that involves a change in the chemical composition either of the converter material or the substance of the LED.

It is an object of the present invention to provide a light emitting device which allows for most applications an easier setting and adjustment of the color temperature of the LED with high color rendition properties.

This object is solved by a light emitting device according to claim 1 of the present invention and by a method according to claim 9 of the present application. Accordingly, a light emitting device, especially a LED is provided, comprising a ceramic garnet material.

It has been surprisingly found out that in a light emitting device which uses such a ceramic garnet material, in most applications within the present invention, LEDs with a CCT (correlated color temperature) of a wide range, in some applications from 2500K-6100K can be realized with a color rendering index (CRI) above 70.

A CRI of 100 is an indication that the light emitted from the light source is identical to that from an incandescent or halogen lamp for CCT<5000 K in the visible spectral range from 380-780 nm or identical to a ‘sun-like’ spectrum as defined by CIE Pub 13.3 (CIE 13.3:1995, Method of Measuring and Specifying Colour Rendering Properties of Light Sources.).

The adjustment of the LED can e.g. be achieved by the method described below.

The term “ceramic material” in the sense of the present invention means and/or includes especially a crystalline or polycrystalline compact material or composite material with a controlled amount of pores or which is pore free.

The term “polycrystalline material” in the sense of the present invention means and/or includes especially a material with a volume density larger than 90 percent of the main constituent, consisting of more than 80 percent of single crystal domains, with each domain being larger than 0.5 μm in diameter and having different crystallographic orientations. The single crystal domains may be connected by amorphous or glassy material or by additional crystalline constituents.

The term “garnet material” in the sense of the present invention means and/or includes especially a cubic or tetragonal-pseudocubic material M^{I}₃M^{II}₂(M^{III}X₄)₃ with M^{I} selected out of the group Mg, Ca, Y, Na, Sr, Gd, La, Ce, Pr, Nd, Sm, Eu, Dy, Tb, Ho, Er, Tm, Yb, Lu or mixtures thereof, M^{II} selected out of the group Al, Ga, Mg, Zn, Y, Ge, Sc, Zr, Ti, Hf or mixtures thereof, M^{III} selected out of the group Al, Si, B, Ge, Ga, V, As, Zn or mixtures thereof, X selected out of the group O, S, N, F, Cl, Br, I, OH and mixtures thereof and built of M^{II}X₆ octahedra and M^{III}X₄ tetrahedra in which each octahedron is joint to six others through vertex-sharing tetrahedra. Each tetrahedron shares its vertices with four octahedra, so that the composition of the framework is (M^{II}X₃)₂(M^{III}X₂)₃. Larger ions M^{I} occupy positions of 8-coordination (dodecahedral) in the interstices of the framework, giving the final composition M^{I}₃M^{II}₂M^{III}₃X₁₂ or M^{I}₃M^{II}₂(M^{III}X₄)₃.

It should be noted that in some garnet materials within the present invention, the M^{II} and M^{III} positions are at least partly occupied by atoms of the same element.

The term “garnet material” in the sense of the present invention furthermore means and/or includes especially a mixture of the material as described above with additives which may be added during ceramic processing. These additives may be incorporated fully or in part into the final material, which then may also be a composite of several chemically different species and particularly include such species known to the art as fluxes. Suitable fluxes include alkaline earth—or alkaline—metal oxides and fluorides, SiO₂ and the like.

According to one embodiment of the present invention, the ceramic garnet material contains nitrogen. In most applications of the present invention, this has greatly helped to achieved the beneficial effects of the invention.

According to one embodiment of the present invention, the ceramic garnet material is selected from the material M^{I}₃M^{II}₂(M^{III}X₄)₃ with M^{I} selected out of the group Y, Gd, La, Ce, Pr, Nd, Sm, Eu, Dy, Tb, Ho, Er, Tm, Yb, Lu or mixtures thereof, M^{II} selected out of the group Al, Ga, Ge, Sc, Zr, Ti, Hf or mixtures thereof, Mm selected out of the group Al, Si, B, Ge, Ga or mixtures thereof and X selected out of the group O, N and mixtures thereof.

According to one embodiment of the present invention, the ceramic garnet material is selected from the material M^{I}₃M^{II}₂(M^{III}X₄)₃ with M^{I} selected out of the group Y, Gd, La, Ce, Sm, Pr or mixtures thereof, M^{II} is Al, M^{III} selected out of the group Al, Si or mixtures thereof and X selected out of the group O, N and mixtures thereof.

According to one embodiment of the present invention, the quotient of the sum of M^{I} atoms (Y, Lu, Gd, Pr, Sm, Tb, Dy, Ho, Er, Tm, Yb, La, Ce, Ca) and the sum of M^{II}+M^{III} atoms (Al, B, Ga, Sc, Si, Ge, Zr, Hf) in the ceramic garnet material is ≧0.55 to ≦0.66, whereby the “sum of (X,Y,Z)” means the added amount of atoms X, Y and Z.

According to one embodiment of the present invention, the quotient of the sum of (Y, Lu, Gd, Pr, Sm, Tb, Dy, Ho, Er, Tm, Yb, La, Ce) and the sum of (Al, B, Ga, Sc, Si, Ge, Zr, Hf) in the ceramic garnet material is ≧0.598 to ≦0.602.

According to one embodiment of the present invention, the ceramic garnet material with a transparency for normal incidence in air of ≧10% to ≦85% for light in the wavelength range from ≧550 nm to ≦1000 nm.

Preferably, the transparency for normal incidence is in air of ≧20% to ≦80% for light in the wavelength range from ≧550 nm to ≦1000 nm, more preferred ≧30% to ≦75% and most preferred >40% to <70% for a light in the wavelength range from ≧550 nm to ≦1000 nm.

The term “transparency” in the sense of the present invention means especially that ≧10% preferably ≧20%, more preferred ≧30%, most preferred ≧40% and ≦85% of the incident light of a wavelength, which cannot be absorbed by the material, is transmitted through the sample for normal incidence in air (at an arbitrary angle). This wavelength is preferably in the range of ≧550 nm and ≦1000 nm.

According to a preferred embodiment of the present invention, the amount of glass phase of the ceramic garnet material is ≧0.002 (vol-) % to ≦1 (vol-) %, more preferred ≧0.003 (vol-) % to ≦0.4 (vol-) %. It has been shown in practice that materials with such a glass phase ratio show the improved characteristics, which are advantageous and desired for the present invention.

The term “glass phase” in the sense of the present invention means especially non-crystalline grain boundary phases, which may be detected by scanning electron microscopy or transmission electron microscopy.

According to a preferred embodiment of the present invention, the surface roughness RMS (disruption of the planarity of a surface; measured as the geometric mean of the difference between highest and deepest surface features) of the surface(s) of the ceramic garnet material is ≧0.001 μm and ≦100 μm. According to an embodiment of the present invention, the surface roughness of the surface(s) of the ceramic garnet material is ≧0.01 μm and ≦10 μm, according to an embodiment of the present invention ≧0.1 μm and ≦5 μm, according to an embodiment of the present invention ≧0.15 μm and ≦3 μm. and according to an embodiment of the present invention ≧0.2 μm and ≦2 μm.

According to a preferred embodiment of the present invention, the specific surface area of the ceramic garnet material structure is ≧10⁻⁷ m²/g and ≦1 m²/g.

According to a preferred embodiment of the present invention, the ceramic garnet material has a density of ≧95% and ≦99.8% of the theoretical density.

It has been shown that in most applications within the present invention, it is advantageous if the ceramic garnet material is not fully dense but allows for some pores as will be described later on.

According to a preferred embodiment of the present invention, the ceramic garnet material has a density of ≧97% and ≦99.2% of the theoretical density

According to a preferred embodiment of the present invention, the ceramic garnet material has pores, which essentially have a diameter from ≧250 nm to ≦5500 nm.

The term “essentially” means that more than 90%, preferably more than 95% and most preferred more than 98% of the pores have such a diameter within a range of +−15%.

According to a preferred embodiment of the present invention, the ceramic garnet material has pores which essentially have a diameter from ≧350 nm to ≦3600 nm, according to a preferred embodiment of the present invention, the ceramic garnet material has pores which essentially have a diameter from ≧400 nm to ≦2700 nm.

According to a preferred embodiment of the present invention, the pores of the ceramic garnet material have essentially a log-norm-Distribution, which has a width of ≦300 nm.

The term “essentially” means that more than 90%, preferably more than 95% and most preferred more than 98% of the pores follow this distribution.

According to a preferred embodiment of the present invention, the pores of the ceramic garnet material have essentially a log-norm-Distribution, which has a width of ≦100 nm.

According to a preferred embodiment of the present invention, the pore volume concentration inside the ceramic garnet material is ≦2.5%, according to an embodiment of the present invention ≦2%.

It has been shown that a ceramic garnet material with pores which have a diameter and a distribution as described above has for most applications within the present invention greatly improved lighting characteristics. In this regard, it is referred to the EP 06111437.7 which is incorporated by reference.

According to a preferred embodiment of the present invention, the ceramic garnet material comprises as a major constituent a material selected out of the group comprising (Y_{1-y}Gd_{y})₃₋ₓAl_{5-z}Si_{z}O_{12-z}N_{z}:Ceₓ with 0.002≦x≦0.03, 0≦y≦0.3 and 0.01≦z≦0.25, (Lu_{1-y}Y_{y})₃₋ₓAl_{5-z}Si_{z}O_{12-z}N_{z}:Ceₓ with 0.002≦x≦0.03, 0≦y≦1 and 0.01≦z≦0.5, (Lu_{1-y}Y_{y})₃₋ₓ₋ₐAl_{5-z}Si_{z}O_{12-z}N_{z}:CeₓSmₐ with 0.002≦x≦0.03, 0≦y≦1, 0.01≦z≦0.5, and 0.001≦a≦0.03, (Lu_{1-y}Y_{y})₃₋ₓ₋ₐAl_{5-z}Si_{z}O_{12-z}N_{z}:CeₓPrₐ with 0.002≦x≦0.03, 0≦y≦1, 0.01≦z≦0.5, and 0.001≦a≦0.03, or mixtures thereof.

The term “major constituent” means especially that ≧95%, preferably ≧97% and most preferred ≧99% of the ceramic garnet material consists out of this material. However, in some applications, trace amounts of additives may also be present in the bulk compositions. These additives particularly include such species known to the art as fluxes. Suitable fluxes include alkaline earth—or alkaline—metal oxides and fluorides, SiO₂ and the like and mixtures thereof.

According to an embodiment of the present invention, the ceramic garnet material comprises grains, whereby 50% of all garnet grains have a diameter in the range of ≧5 and ≦15 μm range.

It has been shown that in some applications within the present invention this distribution of grains leads to an advantageous distribution of pores, especially an advantageous distribution of pore size, which increases the lighting properties of the light emitting device.

According to an embodiment of the present invention, the ceramic garnet material comprises grains, whereby ≦5% of all garnet grains may have average diameters in the range of ≧1 μm and ≦5 μm.

According to an embodiment of the present invention, the ceramic garnet material comprises grains, whereby ≧90% of all garnet grains may have average diameters in the range of ≦20 μm.

According to an embodiment of the present invention, the light emitting device furthermore comprises a N-containing monoclinic material.

The term “N-containing monoclinic material” means, includes and/or describes a material which contains nitrogen and which has a monocline structure

It has been surprisingly shown that this second material in some applications of the present invention acts as scattering centres in the ceramic matrix and thus enhances the light mixing property of the ceramic garnet material in the light emitting device.

According to an embodiment of the present invention, the N-containing monoclinic material is a N-YAM material

The term “N-YAM” material means, includes and/or describes a material of the composition M₄Al₂₋ₓSiₓO₉₋ₓNₓ with M being a member or the group consisting of Y, Lu, Gd, Pr, Sm, Tb, Dy, Ho, Er, Tm, Yb, La, Ce and mixtures thereof.

According to an embodiment of the present invention, the ratio of the N-containing monoclinic material to the ceramic garnet material is ≧0.001:1 to ≦0.02:1.

According to an embodiment of the present invention, the volume ratio of the N-containing monocline material to the ceramic garnet material is ≧0.0002:1 to ≦0.05:1.

The present invention furthermore relates to a method of producing a ceramic garnet material for a light emitting device according to the present invention comprising a sintering step.

The term “sintering step” in the sense of the present invention means especially densification of a precursor powder under the influence of heat, which may be combined with the application of uniaxial or isostatic pressure, without reaching the liquid state of the main constituents of the sintered material.

According to a preferred embodiment of the present invention, the sintering step is pressureless, preferably in reducing or inert atmosphere.

According to a preferred embodiment of the present invention, the method furthermore comprises the step of pressing the ceramic garnet precursor material to ≧50% to ≦70%, preferably ≧55% to ≦65%, of its theoretical density before sintering. It has been shown in practice that this improves the sintering steps for most ceramic garnet materials as described with the present invention.

According to a preferred embodiment of the present invention, the method of producing a ceramic garnet material for a light emitting device according to the present invention comprises the following steps:
(a) Mixing the precursor materials for the ceramic garnet material
(b) optional firing of the precursor materials, preferably at a temperature of ≧1300° C. to ≦1700° C. to remove volatile materials (such as CO₂ in case carbonates are used)
(c) optional grinding and washing
(d) a first pressing step, preferably a unixial pressing step using a suitable powder compacting tool with a mould in the desired shape (e.g. rod- or pellet-shape) and/or a cold isostatic pressing step preferably at ≧3000 bar to ≦5000 bar.
(e) a sintering step at ≧1500° C. to ≦2200° C. in an inert or reducing atmosphere with a pressure of ≧10⁻⁷ mbar to ≦10⁴ mbar.
(f) an optional hot pressing step, preferably a hot isostatic pressing step preferably at ≧30 bar to ≦2500 bar and preferably at a temperature of ≧1500° C. to ≦2000° C. and/or a hot uniaxial pressing step preferably at ≧100 bar to ≦2500 bar and preferably at a temperature of ≧1500° C. to ≦2000° C.
(g) optionally a post annealing step at ≧1000° C. to ≦1700° C. in inert atmosphere or in an oxygen containing atmosphere.

According to this method, for most desired material compositions this production method has produced the best ceramic garnet materials as used in the present invention.

The invention furthermore relates to a method of obtaining a light emitting device as described above with a desired color temperature and/or adjusting a light emitting device as described above to a desired color temperature comprising the steps of
Producing a ceramic garnet material as described above, preferably by a method as described above
Measuring the pore size, distribution and concentration in the ceramic garnet material
Deriving the required thickness of the ceramic garnet material for obtaining a light emitting device with the desired color temperature and distance to the white color point of the reference light source with that CCT
optionally reducing the thickness and/or the pore size, distribution and/or concentration to adjust the light emitting device using the ceramic garnet material to the desired color temperature

It has been surprisingly shown that with this method, for most applications within the present invention, a correlated color temperature (CCT) with a color point close to the color point of the reference light source can be reached for any LED emitting at least partially within the absorption band of the phosphor material by changing only the Si—N content of the phosphor and/or the converter material.

In a wider scope and according to one embodiment of the present invention, the method is conducted as follows:

Starting with a blue emitting LED a ceramic garnet material of the present invention is added absorbing a fraction of the LED light to be reemitted by the ceramic garnet material. The emission properties of the ceramic garnet material are adjusted by the Si, N content in order to achieve a mixed colour point close to the desired correlated colour temperature (CCT). The light emitting device is then treated according to the method as described above in order to obtain a light emitting device as described above with a desired color temperature and/or adjust a light emitting device as described above to a desired color temperature and a color point with a vector distance to the corresponding colour point of a white light source, being a black body radiator for CCT<5000K or a CIE defined sun-like spectrum for CCT>5000K, of less than Δu′v′<0.015 measured in CIE 1976 colour space.

A light emitting device according to the present invention as well as a ceramic garnet material as produced with the present method may be of use in a broad variety of systems and/or applications, amongst them one or more of the following:
Office lighting systems
household application systems
shop lighting systems,
home lighting systems,
accent lighting systems,
spot lighting systems,
theater lighting systems,
fiber-optics application systems,
projection systems,
self-lit display systems,
pixelated display systems,
segmented display systems,
warning sign systems,
medical lighting application systems,
indicator sign systems, and
decorative lighting systems
portable systems
automotive applications
green house lighting systems

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, features, characteristics and advantages of the object of the invention are disclosed in the subclaims, the figures and the following description of the respective figures and examples, which—in an exemplary fashion—show several embodiments and examples of a ceramic garnet material for use in a light emitting device according to the invention as well as several embodiments and examples of a light emitting device according to the invention.

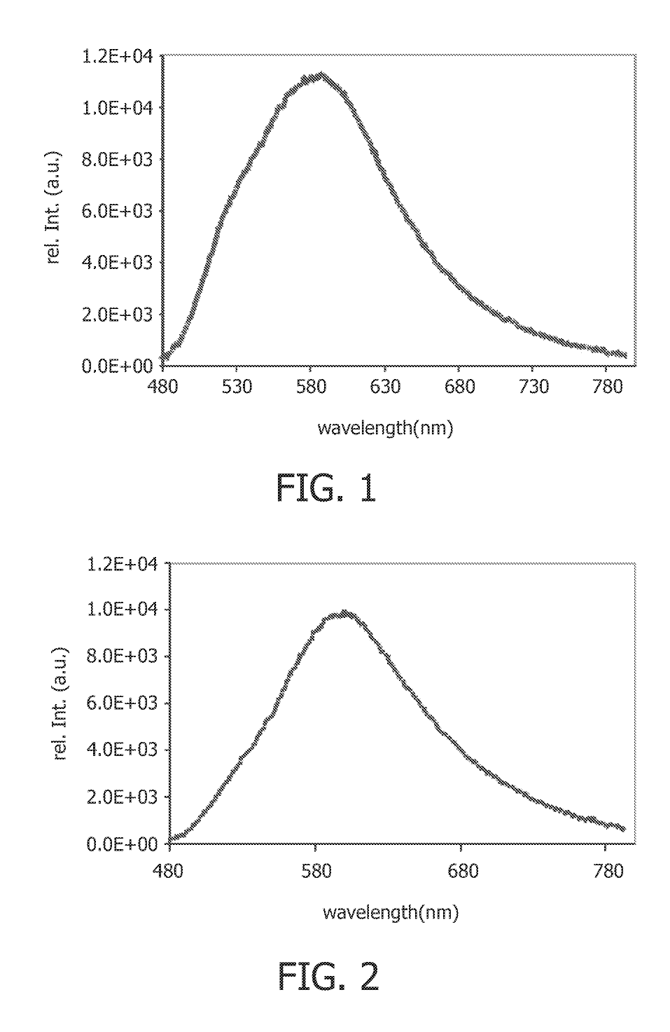

FIG. 1 shows an emission spectrum of a ceramic garnet material according to Example I of the present invention

FIG. 2 shows an emission spectrum of a ceramic garnet material according to Example II of the present invention

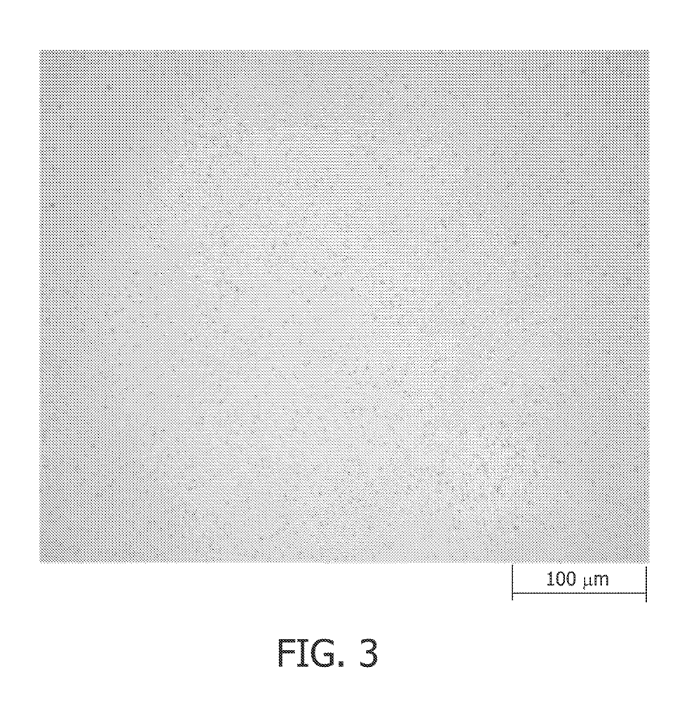

FIG. 3 shows a micrograph of a polished surface of a ceramic SiAlON garnet according to Example II of the present invention

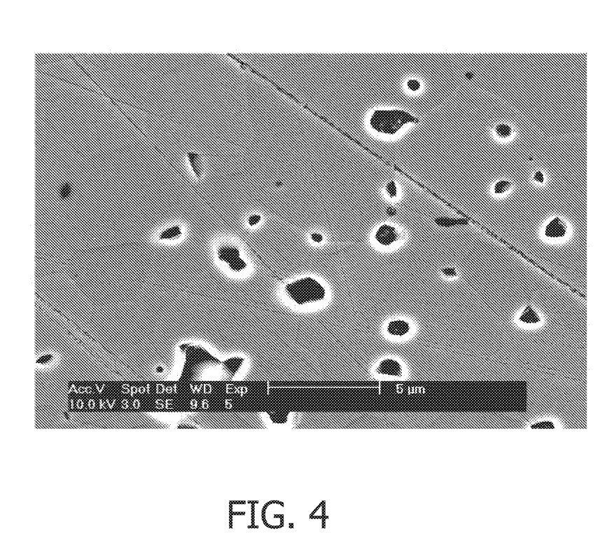

FIG. 4 shows a SEM image of an etched surface of a ceramic garnet material according to Example II of the present invention

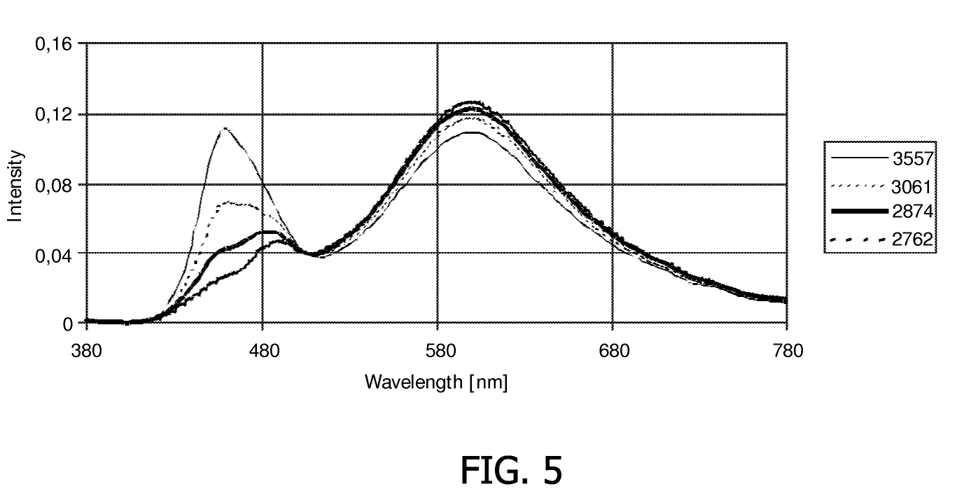

FIG. 5 shows four white pcLED emission spectra for four LEDs employing a SiAlON garnet material according to Example II of the present invention with different correlated color temperatures using an emitter material having a median wavelength of 463 nm.

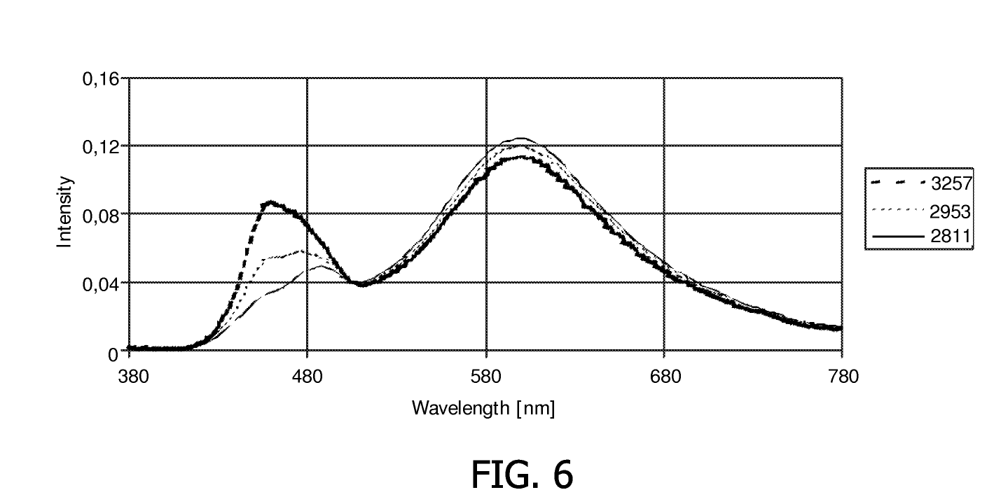

FIG. 6 shows three white pcLED emission spectra for three LEDs employing a SiAlON garnet material according to Example II of the present invention with different correlated color temperatures using an emitter material having a median wavelength of 463 nm.

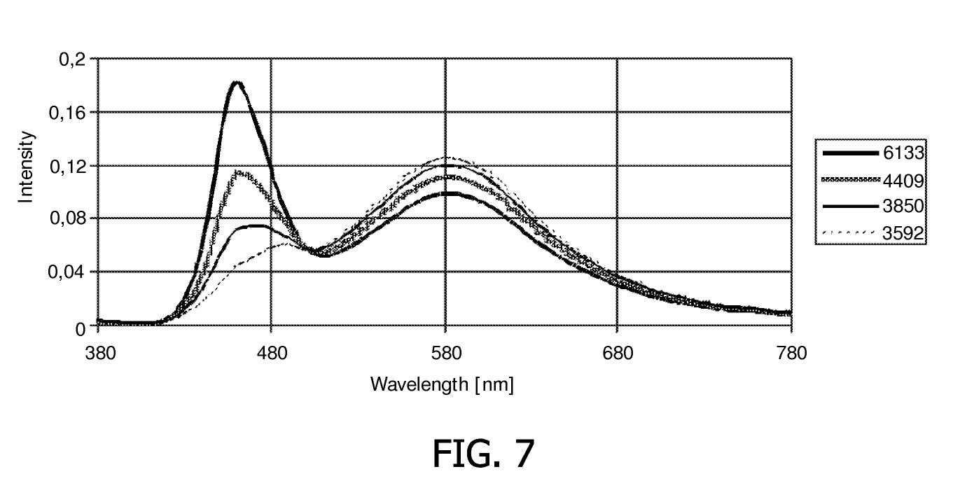

FIG. 7 shows four white pcLED emission spectra for four LEDs employing a SiAlON garnet material according to Example I of the present invention with different correlated color temperatures using an emitter material having a median wavelength of 463 nm.

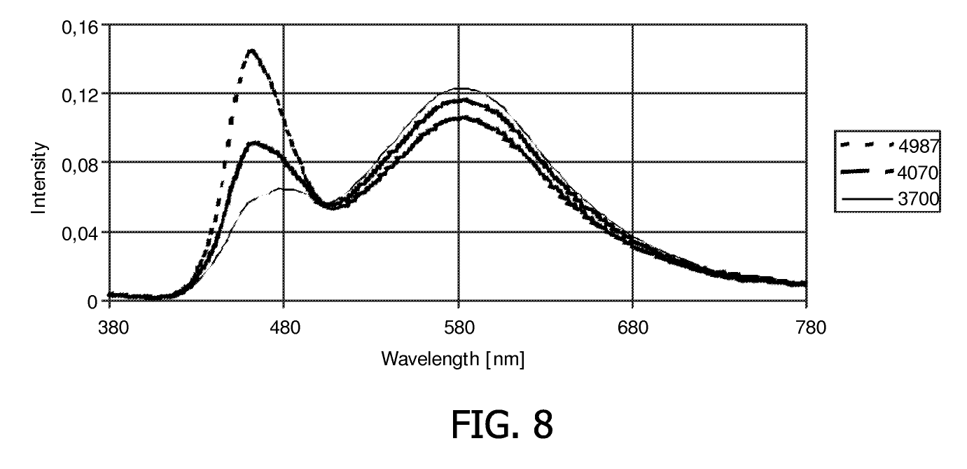

FIG. 8 shows three white pcLED emission spectra for three LEDs employing a SiAlON garnet material according to Example I of the present invention with different correlated color temperatures using an emitter material having a median wavelength of 463 nm

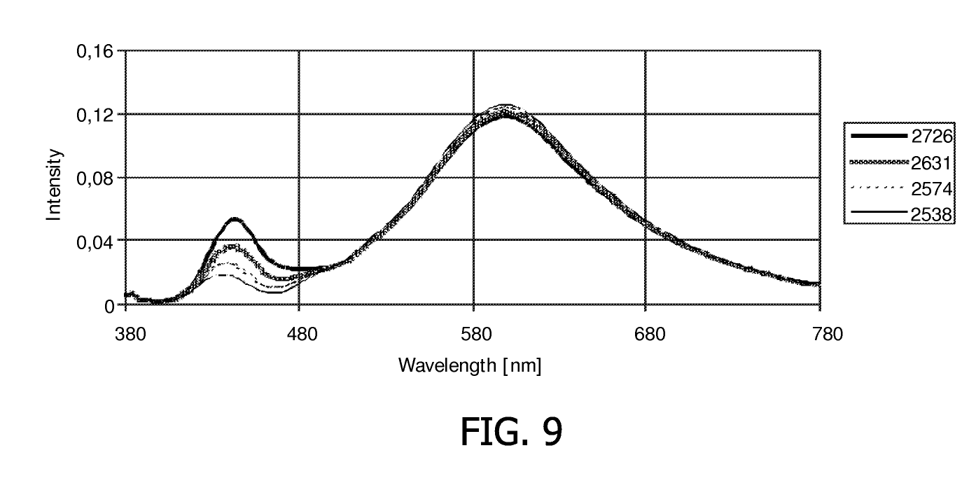

FIG. 9 shows four white pcLED emission spectra for four LEDs employing a SiAlON garnet material according to Example II of the present invention with different correlated color temperatures using an emitter material having a median wavelength of 453 nm; and

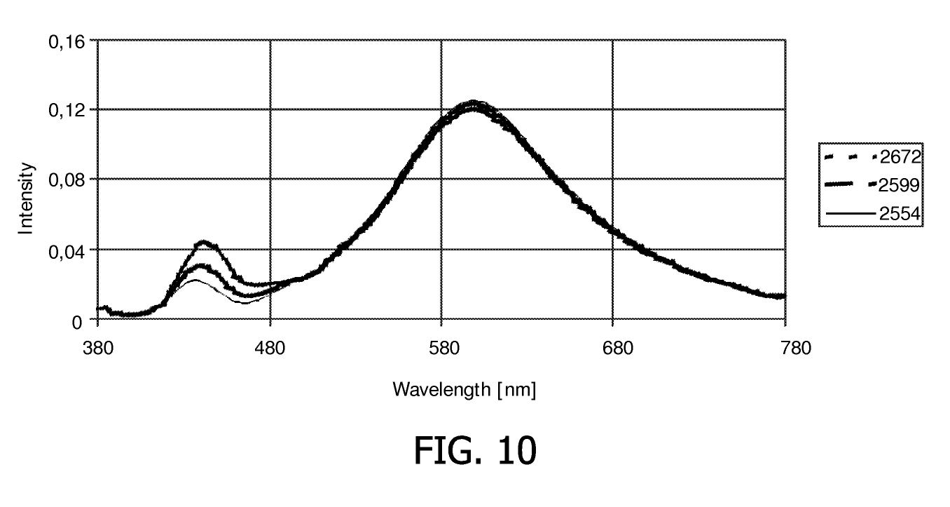

FIG. 10 shows three white pcLED emission spectra for three LEDs employing a SiAlON garnet material according to Example II of the present invention with different correlated color temperatures using an emitter material having a median wavelength of 453 nm.

### EXAMPLE I

The FIGS. 1, 7 and 8 refer to Y_{2.994}Ce_{0.006}Al_{4.9}Si_{0.009}O₁₂₋ₓNₓ (x˜0.1) (=Example I), which was produced with the method as described above out of the following precursors: 100.00 g Al₂O₃, 138.12 g Y₂O₃, 0.412 g CeO₂, and 1.70 g Si₃N₄.

FIG. 1 shows an emission spectra of a ceramic garnet material according to Example I.

### EXAMPLE II

The FIGS. 2 to 6, 9 and 10 refer to Y_{2.994}Ce_{0.006}Al_{4.9}Si_{0.09}O₁₂₋ₓNₓ (x˜0.2) (=Example II) which was produced with the method as described above out of the following precursors: 100.00 g Al₂O₃, 141.00 g Y₂O₃, 0.421 g CeO₂, and 3.66 g Si₃N₄.

FIG. 2 shows an emission spectra of a ceramic garnet material according to Example II.

FIG. 3 illustrates the microstructure of Example II after sintering at 1700° C. in reducing atmosphere and polishing with a SiC based polishing media. Pores can be detected as randomly distributed dark spots, whereas the pore diameter lies in the 500 nm-2000 nm range. The found pore concentration of ˜1.5% (determined from density measurement) and pore size lies in the preferred range as described above.

FIG. 4 shows a SEM image of the same color converter surface with pores that can be detected as black spots with bright surroundings. The average grain size of the SiAlON garnet matrix as derived from SEM measurements lies in the 5-10 μm range.

The FIGS. 5 to 10 show several emission spectra of LEDs using the SiAlON material according to Examples I and II. These LEDs were made as follows:

12 mm diameter ceramic garnet material of Example I or I) was ground and polished to thickness values between 200 and 400 μm. Polished plates were diced to tiles of 1160×1300 μm².

White LEDs were made with flip-chip type blue LEDs, gluing one SiAlON garnet ceramic tile with Silicone to the transparent substrate of the LED die.

FIG. 5 shows four white pcLED emission spectra for four LEDs employing a SiAlON garnet material according to Example II of the present invention with different correlated color temperatures using an emitter material having a median wavelength of 463 nm.

FIG. 6 shows three white pcLED emission spectra for three LEDs employing a SiAlON garnet material according to Example I of the present invention with different correlated color temperatures using an emitter material having a median wavelength of 463 nm.

The emission data of the curves shown in FIGS. 5 and 6 can be found in Table I. Table II shows the chromacity data and CRI for the spectra and LEDs shown in FIGS. 5 and 6.

From Table II can be seen that a change in the thickness T of the SiAlON garnet material (see the highlighted line in Table II) leads to a dramatic change in the CCT, i.e. from 3557 CCT for 250 μm to 2672 CCT for 440 μm thickness, while the Δu′v′ measured in CIE 1976 colour space remains <0.015 for all LEDs.

FIG. 7 shows four white pcLED emission spectra for four LEDs employing a SiAlON garnet material according to Example I of the present invention with different correlated color temperatures using an emitter material having a median wavelength of 463 nm.

FIG. 8 shows three white pcLED emission spectra for three LEDs employing a SiAlON garnet material according to Example II of the present invention with different correlated color temperatures using an emitter material having a median wavelength of 463 nm.

The emission data of the curves shown in FIGS. 7 and 8 can be found in Table III. Table IV shows the chromacity data and CRI for the spectra and LEDs shown in FIGS. 7 and 8.

From Table IV can be seen that a change in the thickness T of the SiAlON garnet material (see the highlighted line in Table IV) leads to a dramatic change in the CCT, i.e. from 6133 CCT for 190 μm to 3592 CCT for 440 μm thickness while the Δu′v′ measured in CIE 1976 colour space remains <0.015 for all LEDs.

FIG. 9 shows four white pcLED emission spectra for four LEDs employing a SiAlON garnet material according to Example II of the present invention with different correlated color temperatures using an emitter material having a median wavelength of 453 nm.

FIG. 10 shows three white pcLED emission spectra for three LEDs employing a SiAlON garnet material according to Example II of the present invention with different correlated color temperatures using an emitter material having a median wavelength of 453 nm.

The emission data of the curves shown in FIGS. 9 and 10 can be found in Table V. Table VI shows the chromacity data and CRI for the spectra and LEDs shown in FIGS. 9 and 10.

From Table VI can be seen that a change in the thickness T of the SiAlON garnet material (see the highlighted line in Table IV) leads to a dramatic change in the CCT, i.e. from 2726 CCT for 380 μm thickness to 2538 CCT for 570 μm thickness while the Δu′v′ measured in CIE 1976 colour space remains <0.015 for all LEDs.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

TABLE I
Emission data of the LEDs according to FIGS. 5 and 6

| | CCT | CCT | CCT | CCT | CCT | CCT | CCT |
|---|---|---|---|---|---|---|---|
| nm | 3557 K | 3257 K | 3061 K | 2953 K | 2874 K | 2811 K | 2762 K |
| 380 | 0.002012 | 0.00198 | 0.001952 | 0.001927 | 0.001903 | 0.001882 | 0.001862 |
| 382 | 0.001628 | 0.001593 | 0.001562 | 0.001533 | 0.001507 | 0.001483 | 0.001461 |
| 384 | 0.001419 | 0.001383 | 0.001351 | 0.001321 | 0.001294 | 0.001269 | 0.001246 |
| 386 | 0.001045 | 0.001005 | 0.000968 | 0.000935 | 0.000904 | 0.000875 | 0.000848 |
| 388 | 0.001189 | 0.001144 | 0.001102 | 0.001064 | 0.001028 | 0.000995 | 0.000963 |
| 390 | 0.001175 | 0.001125 | 0.001079 | 0.001037 | 0.000997 | 0.00096 | 0.000925 |
| 392 | 0.000837 | 0.000795 | 0.000757 | 0.000722 | 0.00069 | 0.000659 | 0.000631 |
| 394 | 0.000709 | 0.000669 | 0.000632 | 0.000598 | 0.000567 | 0.000538 | 0.000511 |
| 396 | 0.00066 | 0.000619 | 0.000581 | 0.000546 | 0.000514 | 0.000484 | 0.000456 |
| 398 | 0.000721 | 0.000677 | 0.000636 | 0.000598 | 0.000563 | 0.00053 | 0.000499 |
| 400 | 0.000616 | 0.000573 | 0.000535 | 0.000499 | 0.000466 | 0.000435 | 0.000407 |
| 402 | 0.000445 | 0.000408 | 0.000374 | 0.000343 | 0.000314 | 0.000288 | 0.000263 |
| 404 | 0.000472 | 0.000433 | 0.000397 | 0.000365 | 0.000335 | 0.000307 | 0.00028 |
| 406 | 0.000761 | 0.000711 | 0.000665 | 0.000622 | 0.000583 | 0.000545 | 0.00051 |
| 408 | 0.000982 | 0.000923 | 0.000868 | 0.000816 | 0.000768 | 0.000722 | 0.00068 |
| 410 | 0.001063 | 0.000998 | 0.000938 | 0.000881 | 0.000828 | 0.000778 | 0.00073 |
| 412 | 0.001361 | 0.00128 | 0.001204 | 0.001132 | 0.001065 | 0.001002 | 0.000943 |
| 414 | 0.001862 | 0.001752 | 0.001649 | 0.001552 | 0.001462 | 0.001376 | 0.001295 |
| 416 | 0.002515 | 0.002361 | 0.002217 | 0.002083 | 0.001956 | 0.001837 | 0.001725 |
| 418 | 0.003133 | 0.002923 | 0.002727 | 0.002545 | 0.002374 | 0.002215 | 0.002065 |
| 420 | 0.004113 | 0.00381 | 0.00353 | 0.00327 | 0.003029 | 0.002806 | 0.002598 |
| 422 | 0.005447 | 0.005004 | 0.004598 | 0.004225 | 0.003883 | 0.003568 | 0.003278 |
| 424 | 0.007242 | 0.00659 | 0.005999 | 0.005461 | 0.004972 | 0.004527 | 0.004122 |
| 426 | 0.009684 | 0.008719 | 0.007852 | 0.007072 | 0.006372 | 0.005741 | 0.005173 |
| 428 | 0.012575 | 0.011189 | 0.009959 | 0.008868 | 0.007898 | 0.007036 | 0.00627 |
| 430 | 0.016005 | 0.01407 | 0.012375 | 0.01089 | 0.009586 | 0.008441 | 0.007435 |
| 432 | 0.020133 | 0.017479 | 0.015184 | 0.013197 | 0.011476 | 0.009984 | 0.008689 |
| 434 | 0.02516 | 0.02156 | 0.018488 | 0.015864 | 0.013621 | 0.011702 | 0.010058 |
| 436 | 0.030838 | 0.026076 | 0.022067 | 0.018689 | 0.015839 | 0.013432 | 0.011398 |
| 438 | 0.037115 | 0.03097 | 0.025863 | 0.021617 | 0.018081 | 0.015134 | 0.012676 |
| 440 | 0.044476 | 0.036639 | 0.030209 | 0.024928 | 0.020587 | 0.017014 | 0.01407 |
| 442 | 0.052793 | 0.042972 | 0.035006 | 0.02854 | 0.023287 | 0.019014 | 0.015534 |
| 444 | 0.061802 | 0.049756 | 0.040089 | 0.032324 | 0.026081 | 0.021057 | 0.01701 |
| 446 | 0.071186 | 0.056776 | 0.045312 | 0.036185 | 0.028913 | 0.023114 | 0.018486 |
| 448 | 0.080916 | 0.06405 | 0.050724 | 0.040189 | 0.031856 | 0.02526 | 0.020034 |
| 450 | 0.090232 | 0.071027 | 0.05593 | 0.044055 | 0.034711 | 0.027353 | 0.021557 |
| 452 | 0.098307 | 0.077117 | 0.060508 | 0.047483 | 0.037267 | 0.029249 | 0.022955 |
| 454 | 0.104557 | 0.081903 | 0.064165 | 0.050272 | 0.039386 | 0.030855 | 0.024167 |
| 456 | 0.108712 | 0.085203 | 0.066782 | 0.052344 | 0.041025 | 0.032148 | 0.025184 |
| 458 | 0.110745 | 0.087006 | 0.06836 | 0.05371 | 0.042197 | 0.033146 | 0.026029 |
| 460 | 0.110777 | 0.087414 | 0.068987 | 0.054449 | 0.042975 | 0.033916 | 0.026761 |
| 462 | 0.109278 | 0.086764 | 0.068908 | 0.05474 | 0.043493 | 0.034559 | 0.02746 |
| 464 | 0.106915 | 0.085558 | 0.068504 | 0.054875 | 0.043976 | 0.035254 | 0.028269 |
| 466 | 0.104345 | 0.084305 | 0.068171 | 0.055169 | 0.04468 | 0.036211 | 0.029366 |
| 468 | 0.101789 | 0.083176 | 0.068054 | 0.055752 | 0.045732 | 0.037559 | 0.030883 |
| 470 | 0.09914 | 0.082021 | 0.067979 | 0.05644 | 0.046943 | 0.039113 | 0.032646 |
| 472 | 0.09635 | 0.080788 | 0.067895 | 0.057191 | 0.048285 | 0.040861 | 0.034658 |
| 474 | 0.093306 | 0.079295 | 0.067571 | 0.057736 | 0.049465 | 0.042493 | 0.036601 |
| 476 | 0.090084 | 0.077662 | 0.067164 | 0.058267 | 0.050704 | 0.044257 | 0.038746 |
| 478 | 0.086405 | 0.075566 | 0.066318 | 0.058402 | 0.051605 | 0.045748 | 0.040687 |
| 480 | 0.082208 | 0.072889 | 0.064868 | 0.057938 | 0.05193 | 0.046703 | 0.042139 |
| 482 | 0.077978 | 0.070103 | 0.063269 | 0.057316 | 0.05211 | 0.047539 | 0.043511 |
| 484 | 0.073852 | 0.067314 | 0.061601 | 0.056588 | 0.052171 | 0.048263 | 0.044792 |
| 486 | 0.070069 | 0.064768 | 0.060109 | 0.055996 | 0.052349 | 0.049101 | 0.046196 |
| 488 | 0.066126 | 0.061907 | 0.058183 | 0.054879 | 0.051936 | 0.049302 | 0.046935 |
| 490 | 0.062182 | 0.058899 | 0.055988 | 0.053396 | 0.051077 | 0.048992 | 0.047112 |
| 492 | 0.058428 | 0.055942 | 0.053728 | 0.051749 | 0.049972 | 0.048369 | 0.046917 |
| 494 | 0.054934 | 0.053109 | 0.051478 | 0.050012 | 0.04869 | 0.047494 | 0.046407 |
| 496 | 0.051487 | 0.050195 | 0.04903 | 0.047976 | 0.047019 | 0.046148 | 0.045353 |
| 498 | 0.048215 | 0.047345 | 0.046548 | 0.045816 | 0.045144 | 0.044525 | 0.043955 |
| 500 | 0.045168 | 0.044641 | 0.044142 | 0.043671 | 0.043227 | 0.042809 | 0.042417 |
| 502 | 0.042743 | 0.04251 | 0.042266 | 0.042016 | 0.041766 | 0.041519 | 0.041277 |
| 504 | 0.040942 | 0.040957 | 0.040927 | 0.040864 | 0.040776 | 0.040672 | 0.040557 |
| 506 | 0.039456 | 0.03968 | 0.039828 | 0.039919 | 0.039966 | 0.039979 | 0.039967 |
| 508 | 0.038512 | 0.038919 | 0.039225 | 0.03945 | 0.039613 | 0.039727 | 0.039804 |
| 510 | 0.037637 | 0.038203 | 0.038644 | 0.038985 | 0.039247 | 0.039447 | 0.039598 |
| 512 | 0.037391 | 0.038104 | 0.038669 | 0.039115 | 0.039467 | 0.039744 | 0.039962 |
| 514 | 0.037608 | 0.038453 | 0.039128 | 0.039668 | 0.040101 | 0.040446 | 0.040723 |
| 516 | 0.038073 | 0.039042 | 0.039821 | 0.040448 | 0.040953 | 0.041362 | 0.041692 |
| 518 | 0.038727 | 0.039807 | 0.040679 | 0.041383 | 0.041955 | 0.042418 | 0.042796 |
| 520 | 0.039573 | 0.040762 | 0.041723 | 0.042503 | 0.043137 | 0.043653 | 0.044076 |
| 522 | 0.040657 | 0.041948 | 0.042995 | 0.043845 | 0.044538 | 0.045104 | 0.045568 |
| 524 | 0.041752 | 0.043137 | 0.044261 | 0.045176 | 0.045923 | 0.046534 | 0.047035 |
| 526 | 0.042887 | 0.044362 | 0.04556 | 0.046537 | 0.047334 | 0.047987 | 0.048525 |
| 528 | 0.044056 | 0.045617 | 0.046886 | 0.047921 | 0.048767 | 0.04946 | 0.050031 |
| 530 | 0.045291 | 0.046941 | 0.048283 | 0.049378 | 0.050273 | 0.051008 | 0.051613 |
| 532 | 0.046438 | 0.048172 | 0.049583 | 0.050734 | 0.051675 | 0.052449 | 0.053086 |
| 534 | 0.047991 | 0.049811 | 0.051291 | 0.052499 | 0.053489 | 0.054301 | 0.054971 |
| 536 | 0.049798 | 0.051709 | 0.053263 | 0.054533 | 0.055572 | 0.056426 | 0.05713 |
| 538 | 0.051506 | 0.053509 | 0.05514 | 0.05647 | 0.057561 | 0.058456 | 0.059195 |
| 540 | 0.053269 | 0.055363 | 0.057067 | 0.058459 | 0.059599 | 0.060536 | 0.061309 |
| 542 | 0.055291 | 0.057481 | 0.059265 | 0.060721 | 0.061913 | 0.062894 | 0.063703 |
| 544 | 0.057476 | 0.059766 | 0.061631 | 0.063154 | 0.064402 | 0.065427 | 0.066274 |
| 546 | 0.059499 | 0.061888 | 0.063834 | 0.065423 | 0.066724 | 0.067794 | 0.068677 |
| 548 | 0.061677 | 0.064171 | 0.066202 | 0.067861 | 0.06922 | 0.070337 | 0.07126 |
| 550 | 0.064051 | 0.066651 | 0.068769 | 0.070498 | 0.071915 | 0.07308 | 0.074041 |
| 552 | 0.066581 | 0.069295 | 0.071505 | 0.073309 | 0.074788 | 0.076004 | 0.077007 |
| 554 | 0.069048 | 0.071878 | 0.074181 | 0.076063 | 0.077604 | 0.078872 | 0.079918 |
| 556 | 0.071644 | 0.074586 | 0.076981 | 0.078937 | 0.08054 | 0.081858 | 0.082946 |
| 558 | 0.074411 | 0.077474 | 0.079967 | 0.082004 | 0.083672 | 0.085044 | 0.086177 |
| 560 | 0.077065 | 0.080243 | 0.082831 | 0.084945 | 0.086676 | 0.088101 | 0.089276 |
| 562 | 0.07966 | 0.082953 | 0.085634 | 0.087824 | 0.089619 | 0.091094 | 0.092312 |
| 564 | 0.0822 | 0.085606 | 0.088379 | 0.090644 | 0.092499 | 0.094025 | 0.095285 |
| 566 | 0.084616 | 0.088126 | 0.090984 | 0.093318 | 0.095231 | 0.096804 | 0.098102 |
| 568 | 0.086861 | 0.090471 | 0.093411 | 0.095813 | 0.09778 | 0.099398 | 0.100734 |
| 570 | 0.08922 | 0.092933 | 0.095956 | 0.098425 | 0.100449 | 0.102112 | 0.103486 |
| 572 | 0.091452 | 0.09526 | 0.09836 | 0.100891 | 0.102966 | 0.104672 | 0.10608 |
| 574 | 0.093612 | 0.09751 | 0.100683 | 0.103275 | 0.105399 | 0.107145 | 0.108587 |
| 576 | 0.095721 | 0.099706 | 0.102951 | 0.105601 | 0.107773 | 0.109558 | 0.111032 |
| 578 | 0.097727 | 0.101795 | 0.105108 | 0.107813 | 0.11003 | 0.111853 | 0.113358 |
| 580 | 0.099771 | 0.103918 | 0.107295 | 0.110053 | 0.112313 | 0.114171 | 0.115705 |
| 582 | 0.101632 | 0.105848 | 0.10928 | 0.112084 | 0.114381 | 0.116271 | 0.11783 |
| 584 | 0.10321 | 0.107489 | 0.110974 | 0.11382 | 0.116152 | 0.11807 | 0.119652 |
| 586 | 0.10445 | 0.10878 | 0.112306 | 0.115186 | 0.117545 | 0.119486 | 0.121088 |
| 588 | 0.105552 | 0.109921 | 0.113478 | 0.116384 | 0.118765 | 0.120723 | 0.122339 |
| 590 | 0.106647 | 0.111056 | 0.114646 | 0.117578 | 0.119981 | 0.121957 | 0.123588 |
| 592 | 0.107344 | 0.111781 | 0.115394 | 0.118345 | 0.120763 | 0.122751 | 0.124392 |
| 594 | 0.107822 | 0.112276 | 0.115902 | 0.118864 | 0.121291 | 0.123287 | 0.124935 |
| 596 | 0.108374 | 0.112841 | 0.116478 | 0.119449 | 0.121883 | 0.123885 | 0.125537 |
| 598 | 0.108747 | 0.113225 | 0.116871 | 0.119849 | 0.122289 | 0.124296 | 0.125952 |
| 600 | 0.108885 | 0.113369 | 0.117019 | 0.120001 | 0.122445 | 0.124454 | 0.126113 |
| 602 | 0.108622 | 0.113093 | 0.116734 | 0.119707 | 0.122144 | 0.124147 | 0.125801 |
| 604 | 0.108417 | 0.112876 | 0.116506 | 0.119472 | 0.121901 | 0.1239 | 0.125549 |
| 606 | 0.107797 | 0.112231 | 0.115841 | 0.11879 | 0.121207 | 0.123194 | 0.124834 |
| 608 | 0.106858 | 0.111258 | 0.114841 | 0.117767 | 0.120165 | 0.122136 | 0.123764 |
| 610 | 0.105815 | 0.11017 | 0.113716 | 0.116612 | 0.118985 | 0.120936 | 0.122547 |
| 612 | 0.104677 | 0.10898 | 0.112485 | 0.115347 | 0.117692 | 0.119621 | 0.121212 |
| 614 | 0.103574 | 0.107825 | 0.111287 | 0.114115 | 0.116432 | 0.118337 | 0.11991 |
| 616 | 0.101974 | 0.106159 | 0.109567 | 0.11235 | 0.114631 | 0.116506 | 0.118054 |
| 618 | 0.100439 | 0.104559 | 0.107913 | 0.110653 | 0.112898 | 0.114745 | 0.116269 |
| 620 | 0.098742 | 0.102794 | 0.106093 | 0.108787 | 0.110995 | 0.112811 | 0.11431 |
| 622 | 0.097033 | 0.101015 | 0.104257 | 0.106905 | 0.109075 | 0.11086 | 0.112333 |
| 624 | 0.095071 | 0.098978 | 0.102159 | 0.104757 | 0.106886 | 0.108637 | 0.110082 |
| 626 | 0.092817 | 0.096641 | 0.099756 | 0.102299 | 0.104383 | 0.106097 | 0.107512 |
| 628 | 0.090724 | 0.094469 | 0.097519 | 0.10001 | 0.102051 | 0.103729 | 0.105115 |
| 630 | 0.088653 | 0.09232 | 0.095306 | 0.097744 | 0.099743 | 0.101386 | 0.102742 |
| 632 | 0.086467 | 0.090048 | 0.092964 | 0.095346 | 0.097298 | 0.098903 | 0.100227 |
| 634 | 0.084209 | 0.087706 | 0.090554 | 0.092879 | 0.094785 | 0.096352 | 0.097646 |
| 636 | 0.082078 | 0.085493 | 0.088274 | 0.090545 | 0.092406 | 0.093936 | 0.095199 |
| 638 | 0.080084 | 0.083419 | 0.086133 | 0.088351 | 0.090168 | 0.091662 | 0.092895 |
| 640 | 0.078386 | 0.081645 | 0.084298 | 0.086465 | 0.088241 | 0.089701 | 0.090906 |
| 642 | 0.076371 | 0.079547 | 0.082134 | 0.084246 | 0.085977 | 0.087401 | 0.088576 |
| 644 | 0.074467 | 0.077566 | 0.08009 | 0.08215 | 0.083839 | 0.085228 | 0.086374 |
| 646 | 0.072583 | 0.075603 | 0.078063 | 0.080071 | 0.081717 | 0.083071 | 0.084188 |
| 648 | 0.070737 | 0.073678 | 0.076073 | 0.078029 | 0.079632 | 0.08095 | 0.082038 |
| 650 | 0.068969 | 0.071838 | 0.074173 | 0.076081 | 0.077644 | 0.078929 | 0.07999 |
| 652 | 0.067034 | 0.069827 | 0.0721 | 0.073957 | 0.075479 | 0.07673 | 0.077763 |
| 654 | 0.065082 | 0.067797 | 0.070008 | 0.071813 | 0.073292 | 0.074509 | 0.075513 |
| 656 | 0.063224 | 0.065864 | 0.068013 | 0.069769 | 0.071208 | 0.072391 | 0.073368 |
| 658 | 0.061487 | 0.064056 | 0.066148 | 0.067857 | 0.069257 | 0.070408 | 0.071358 |
| 660 | 0.059831 | 0.062333 | 0.06437 | 0.066033 | 0.067397 | 0.068518 | 0.069443 |
| 662 | 0.05815 | 0.060582 | 0.062562 | 0.06418 | 0.065505 | 0.066595 | 0.067494 |
| 664 | 0.05632 | 0.058682 | 0.060605 | 0.062176 | 0.063463 | 0.064521 | 0.065395 |
| 666 | 0.054903 | 0.057207 | 0.059083 | 0.060615 | 0.061871 | 0.062904 | 0.063756 |
| 668 | 0.053476 | 0.05572 | 0.057548 | 0.05904 | 0.060263 | 0.061269 | 0.062099 |
| 670 | 0.052046 | 0.05423 | 0.056008 | 0.057461 | 0.058651 | 0.059629 | 0.060437 |
| 672 | 0.050583 | 0.052703 | 0.054429 | 0.055839 | 0.056995 | 0.057945 | 0.058729 |
| 674 | 0.049076 | 0.051133 | 0.052809 | 0.054178 | 0.055299 | 0.056221 | 0.056982 |
| 676 | 0.047753 | 0.049753 | 0.051381 | 0.052711 | 0.053801 | 0.054698 | 0.055437 |
| 678 | 0.046338 | 0.048277 | 0.049855 | 0.051144 | 0.0522 | 0.053068 | 0.053785 |
| 680 | 0.045161 | 0.047045 | 0.048579 | 0.049832 | 0.050859 | 0.051704 | 0.052401 |
| 682 | 0.043904 | 0.045734 | 0.047223 | 0.04844 | 0.049437 | 0.050257 | 0.050934 |
| 684 | 0.042588 | 0.044365 | 0.045811 | 0.046993 | 0.047961 | 0.048758 | 0.049415 |
| 686 | 0.041494 | 0.043222 | 0.044629 | 0.045778 | 0.04672 | 0.047494 | 0.048133 |
| 688 | 0.040335 | 0.042015 | 0.043383 | 0.0445 | 0.045416 | 0.046169 | 0.04679 |
| 690 | 0.039367 | 0.041002 | 0.042334 | 0.043422 | 0.044313 | 0.045046 | 0.045651 |
| 692 | 0.038153 | 0.039739 | 0.041031 | 0.042086 | 0.042951 | 0.043661 | 0.044248 |
| 694 | 0.037135 | 0.03868 | 0.039937 | 0.040965 | 0.041806 | 0.042499 | 0.04307 |
| 696 | 0.036116 | 0.037615 | 0.038836 | 0.039833 | 0.04065 | 0.041322 | 0.041876 |
| 698 | 0.035114 | 0.036569 | 0.037753 | 0.03872 | 0.039512 | 0.040164 | 0.040702 |
| 700 | 0.034134 | 0.035547 | 0.036697 | 0.037637 | 0.038407 | 0.03904 | 0.039563 |
| 702 | 0.033125 | 0.034496 | 0.035613 | 0.036525 | 0.037272 | 0.037886 | 0.038394 |
| 704 | 0.032454 | 0.033788 | 0.034873 | 0.03576 | 0.036487 | 0.037084 | 0.037578 |
| 706 | 0.031681 | 0.032976 | 0.034031 | 0.034893 | 0.035599 | 0.036179 | 0.036658 |
| 708 | 0.03092 | 0.032183 | 0.033211 | 0.034051 | 0.034739 | 0.035305 | 0.035772 |
| 710 | 0.030189 | 0.031419 | 0.032422 | 0.03324 | 0.033911 | 0.034462 | 0.034918 |
| 712 | 0.029504 | 0.030699 | 0.031673 | 0.032468 | 0.033119 | 0.033655 | 0.034097 |
| 714 | 0.028746 | 0.029907 | 0.030853 | 0.031625 | 0.032258 | 0.032778 | 0.033208 |
| 716 | 0.027773 | 0.028903 | 0.029822 | 0.030573 | 0.031189 | 0.031695 | 0.032113 |
| 718 | 0.026763 | 0.027855 | 0.028745 | 0.029471 | 0.030067 | 0.030556 | 0.03096 |
| 720 | 0.025897 | 0.026955 | 0.027817 | 0.02852 | 0.029097 | 0.029571 | 0.029962 |
| 722 | 0.024958 | 0.025982 | 0.026815 | 0.027496 | 0.028053 | 0.028512 | 0.028891 |
| 724 | 0.024073 | 0.025065 | 0.025873 | 0.026533 | 0.027074 | 0.027519 | 0.027886 |
| 726 | 0.023354 | 0.024316 | 0.025099 | 0.025739 | 0.026264 | 0.026695 | 0.027051 |
| 728 | 0.022733 | 0.023662 | 0.024417 | 0.025034 | 0.02554 | 0.025956 | 0.026299 |
| 730 | 0.022204 | 0.023106 | 0.02384 | 0.02444 | 0.024931 | 0.025336 | 0.025669 |
| 732 | 0.021828 | 0.022703 | 0.023415 | 0.023997 | 0.024474 | 0.024866 | 0.02519 |
| 734 | 0.021441 | 0.02229 | 0.022981 | 0.023545 | 0.024008 | 0.024388 | 0.024702 |
| 736 | 0.021188 | 0.02201 | 0.02268 | 0.023228 | 0.023676 | 0.024045 | 0.024349 |
| 738 | 0.020528 | 0.021324 | 0.021972 | 0.022501 | 0.022935 | 0.023291 | 0.023586 |
| 740 | 0.019875 | 0.02065 | 0.021282 | 0.021797 | 0.02222 | 0.022567 | 0.022854 |
| 742 | 0.019301 | 0.020051 | 0.020662 | 0.021161 | 0.021569 | 0.021905 | 0.022183 |
| 744 | 0.018731 | 0.019461 | 0.020055 | 0.02054 | 0.020938 | 0.021265 | 0.021535 |
| 746 | 0.017973 | 0.018679 | 0.019253 | 0.019722 | 0.020107 | 0.020423 | 0.020684 |
| 748 | 0.017097 | 0.017781 | 0.018337 | 0.018791 | 0.019163 | 0.01947 | 0.019722 |
| 750 | 0.016541 | 0.017202 | 0.01774 | 0.018179 | 0.018539 | 0.018835 | 0.019079 |
| 752 | 0.015983 | 0.01662 | 0.017138 | 0.017561 | 0.017908 | 0.018193 | 0.018428 |
| 754 | 0.01558 | 0.016198 | 0.016701 | 0.017112 | 0.017448 | 0.017725 | 0.017953 |
| 756 | 0.014886 | 0.015478 | 0.01596 | 0.016354 | 0.016676 | 0.016942 | 0.01716 |
| 758 | 0.014499 | 0.015076 | 0.015546 | 0.01593 | 0.016245 | 0.016503 | 0.016717 |
| 760 | 0.014073 | 0.014632 | 0.015088 | 0.01546 | 0.015764 | 0.016015 | 0.016222 |
| 762 | 0.01372 | 0.014264 | 0.014706 | 0.015068 | 0.015364 | 0.015608 | 0.015809 |
| 764 | 0.013654 | 0.014182 | 0.014612 | 0.014963 | 0.015251 | 0.015488 | 0.015683 |
| 766 | 0.013404 | 0.013913 | 0.014328 | 0.014667 | 0.014945 | 0.015174 | 0.015362 |
| 768 | 0.013171 | 0.013668 | 0.014073 | 0.014404 | 0.014675 | 0.014898 | 0.015082 |
| 770 | 0.012785 | 0.013264 | 0.013654 | 0.013972 | 0.014233 | 0.014448 | 0.014625 |
| 772 | 0.012792 | 0.013262 | 0.013646 | 0.013959 | 0.014215 | 0.014426 | 0.0146 |
| 774 | 0.012769 | 0.013233 | 0.01361 | 0.013918 | 0.014171 | 0.014378 | 0.01455 |
| 776 | 0.012391 | 0.012847 | 0.013219 | 0.013523 | 0.013771 | 0.013976 | 0.014145 |
| 778 | 0.012081 | 0.012537 | 0.012907 | 0.01321 | 0.013458 | 0.013662 | 0.01383 |
| 780 | 0.012053 | 0.012507 | 0.012877 | 0.013179 | 0.013427 | 0.01363 | 0.013798 |

TABLE II
Chromaticity data and CRI for emission spectra shown in FIGS. 5 and 6.

| | CCT [K] | | | | | | |
|---|---|---|---|---|---|---|---|
| | 3557 | 3257 | 3061 | 2953 | 2874 | 2811 | 2762 |
| Ra | 80 | 80 | 80 | 80 | 79 | 79 | 78 |
| Δuv | 0.024 | 0.017 | 0.011 | 0.006 | 0.001 | 0.001 | 0.004 |
| x | 0.3803 | 0.3997 | 0.4165 | 0.4308 | 0.443 | 0.4533 | 0.462 |
| y | 0.3286 | 0.3512 | 0.3707 | 0.3872 | 0.4012 | 0.4129 | 0.4227 |
| LE | 260 | 271 | 279 | 286 | 292 | 297 | 301 |
| MW | 576 | 582 | 587 | 591 | 594 | 597 | 599 |
| [nm] | | | | | | | |
| | T [μm] of the ceramic SiAlON garnet material | | | | | | |
| | 250 | 280 | 310 | 350 | 380 | 410 | 440 |
| R1 | 92.6 | 88.5 | 84.3 | 81.3 | 78.9 | 77 | 75.4 |
| R2 | 86.6 | 92.3 | 96.7 | 98.2 | 95.8 | 93.5 | 91.5 |
| R3 | 73.9 | 77 | 79.8 | 83.2 | 86 | 88.1 | 89.8 |
| R4 | 75.8 | 73.9 | 72.3 | 71.8 | 71.3 | 70.7 | 70.1 |
| R5 | 91.6 | 89.6 | 85.7 | 82.5 | 79.8 | 77.5 | 75.6 |
| R6 | 79.2 | 86 | 91.2 | 94.3 | 94.1 | 92.1 | 89.9 |
| R7 | 72 | 72.6 | 73.4 | 75.1 | 76.5 | 77.6 | 78.4 |
| R8 | 67.2 | 61 | 56.5 | 54.6 | 53.2 | 52 | 51.1 |
| R9 | 49.2 | 31.1 | 18 | 10.2 | 4.3 | −0.5 | −4.3 |
| R10 | 75.5 | 86.5 | 94.9 | 96.2 | 90.6 | 85.9 | 81.9 |
| R11 | 71.3 | 69.5 | 67.9 | 67.3 | 66.7 | 65.9 | 65.1 |
| R12 | 59.6 | 69.5 | 77.4 | 81.9 | 82.3 | 80.3 | 77.3 |
| R13 | 94.7 | 94.1 | 89.7 | 86.1 | 83.2 | 80.8 | 78.9 |
| R14 | 87.1 | 88.3 | 89.4 | 91 | 92.4 | 93.4 | 94.3 |

TABLE III
Emission data of the LEDs according to FIGS. 7 and 8

| | CCT | CCT | CCT | CCT | CCT | CCT | CCT |
|---|---|---|---|---|---|---|---|
| nm | 6133 K | 4987 K | 4409 K | 4070 K | 3850 K | 3700 K | 3592 K |
| 380 | 0.003778 | 0.003758 | 0.003738 | 0.003717 | 0.003697 | 0.003677 | 0.003657 |
| 382 | 0.003354 | 0.003345 | 0.003332 | 0.003317 | 0.0033 | 0.003281 | 0.003262 |
| 384 | 0.002918 | 0.002907 | 0.002893 | 0.002876 | 0.002857 | 0.002837 | 0.002817 |
| 386 | 0.003034 | 0.003038 | 0.003035 | 0.003027 | 0.003014 | 0.002999 | 0.002981 |
| 388 | 0.002732 | 0.002733 | 0.002728 | 0.002718 | 0.002704 | 0.002686 | 0.002667 |
| 390 | 0.002663 | 0.002657 | 0.002644 | 0.002628 | 0.002607 | 0.002585 | 0.00256 |
| 392 | 0.002456 | 0.002461 | 0.002459 | 0.002451 | 0.002438 | 0.002422 | 0.002404 |
| 394 | 0.002237 | 0.002231 | 0.002219 | 0.002203 | 0.002183 | 0.002162 | 0.002139 |
| 396 | 0.002142 | 0.002137 | 0.002127 | 0.002112 | 0.002094 | 0.002073 | 0.002051 |
| 398 | 0.001963 | 0.001937 | 0.00191 | 0.00188 | 0.001849 | 0.001817 | 0.001786 |
| 400 | 0.00206 | 0.002027 | 0.001992 | 0.001955 | 0.001917 | 0.001879 | 0.001841 |
| 402 | 0.002191 | 0.002149 | 0.002106 | 0.002061 | 0.002016 | 0.001971 | 0.001927 |
| 404 | 0.001903 | 0.00186 | 0.001816 | 0.001773 | 0.00173 | 0.001687 | 0.001645 |
| 406 | 0.001805 | 0.001762 | 0.001718 | 0.001674 | 0.001631 | 0.001588 | 0.001546 |
| 408 | 0.001967 | 0.001912 | 0.001858 | 0.001804 | 0.001752 | 0.001701 | 0.001651 |
| 410 | 0.002069 | 0.002004 | 0.001941 | 0.00188 | 0.00182 | 0.001762 | 0.001705 |
| 412 | 0.002156 | 0.002081 | 0.002008 | 0.001937 | 0.001869 | 0.001803 | 0.001739 |
| 414 | 0.002223 | 0.002133 | 0.002047 | 0.001964 | 0.001885 | 0.001809 | 0.001736 |
| 416 | 0.002868 | 0.002732 | 0.002602 | 0.002479 | 0.002362 | 0.002251 | 0.002146 |
| 418 | 0.003737 | 0.00353 | 0.003336 | 0.003153 | 0.00298 | 0.002818 | 0.002666 |
| 420 | 0.004895 | 0.004579 | 0.004285 | 0.004012 | 0.003757 | 0.00352 | 0.003299 |
| 422 | 0.006317 | 0.005847 | 0.005414 | 0.005015 | 0.004648 | 0.00431 | 0.003999 |
| 424 | 0.008367 | 0.007659 | 0.007014 | 0.006428 | 0.005893 | 0.005406 | 0.004962 |
| 426 | 0.011294 | 0.010216 | 0.009247 | 0.008376 | 0.007592 | 0.006886 | 0.00625 |
| 428 | 0.014821 | 0.013235 | 0.011828 | 0.010579 | 0.00947 | 0.008484 | 0.007607 |
| 430 | 0.019105 | 0.01684 | 0.014857 | 0.013119 | 0.011596 | 0.010259 | 0.009084 |
| 432 | 0.024253 | 0.021097 | 0.01837 | 0.016011 | 0.01397 | 0.012201 | 0.010668 |
| 434 | 0.030719 | 0.026361 | 0.022646 | 0.019476 | 0.016768 | 0.014454 | 0.012474 |
| 436 | 0.038224 | 0.032356 | 0.02742 | 0.023265 | 0.019764 | 0.016812 | 0.014319 |
| 438 | 0.046759 | 0.039046 | 0.032645 | 0.027327 | 0.022905 | 0.019223 | 0.016156 |
| 440 | 0.056919 | 0.04691 | 0.038708 | 0.03198 | 0.026455 | 0.021915 | 0.018179 |
| 442 | 0.068949 | 0.05612 | 0.045732 | 0.037311 | 0.03048 | 0.024932 | 0.020423 |
| 444 | 0.082704 | 0.066562 | 0.053627 | 0.043254 | 0.034929 | 0.028241 | 0.022864 |
| 446 | 0.097661 | 0.077853 | 0.062119 | 0.049613 | 0.039666 | 0.031748 | 0.02544 |
| 448 | 0.114212 | 0.090352 | 0.07153 | 0.056675 | 0.044943 | 0.035672 | 0.028342 |
| 450 | 0.131498 | 0.103454 | 0.081438 | 0.064148 | 0.050562 | 0.039882 | 0.031483 |
| 452 | 0.147971 | 0.116039 | 0.091038 | 0.071456 | 0.056115 | 0.044091 | 0.034664 |
| 454 | 0.161818 | 0.126759 | 0.099329 | 0.077861 | 0.061057 | 0.047899 | 0.037594 |
| 456 | 0.172473 | 0.135227 | 0.106053 | 0.083197 | 0.065288 | 0.051252 | 0.040247 |
| 458 | 0.179728 | 0.141302 | 0.111123 | 0.087416 | 0.068788 | 0.054148 | 0.042639 |
| 460 | 0.18275 | 0.144337 | 0.11404 | 0.090137 | 0.071271 | 0.056377 | 0.044613 |
| 462 | 0.181425 | 0.144173 | 0.114628 | 0.091184 | 0.072574 | 0.057793 | 0.046048 |
| 464 | 0.177191 | 0.141881 | 0.113688 | 0.091164 | 0.073156 | 0.058749 | 0.047216 |
| 466 | 0.171797 | 0.138819 | 0.112283 | 0.090911 | 0.073683 | 0.059782 | 0.048554 |
| 468 | 0.165461 | 0.135092 | 0.110445 | 0.090418 | 0.074123 | 0.060849 | 0.050022 |
| 470 | 0.158198 | 0.130626 | 0.108045 | 0.089523 | 0.074305 | 0.061781 | 0.051456 |
| 472 | 0.150231 | 0.125533 | 0.105119 | 0.088211 | 0.07418 | 0.062511 | 0.052788 |
| 474 | 0.142586 | 0.120647 | 0.102344 | 0.087038 | 0.074207 | 0.063425 | 0.054342 |
| 476 | 0.134878 | 0.11565 | 0.099461 | 0.085792 | 0.074218 | 0.064389 | 0.056019 |
| 478 | 0.126538 | 0.109964 | 0.095888 | 0.083893 | 0.073638 | 0.064843 | 0.057276 |
| 480 | 0.11781 | 0.103751 | 0.091714 | 0.081369 | 0.072446 | 0.064721 | 0.058011 |
| 482 | 0.109276 | 0.09756 | 0.087453 | 0.0787 | 0.071088 | 0.064443 | 0.058619 |
| 484 | 0.101713 | 0.092126 | 0.0838 | 0.076539 | 0.070179 | 0.064585 | 0.059645 |
| 486 | 0.094431 | 0.08676 | 0.080059 | 0.074181 | 0.069 | 0.064414 | 0.060338 |
| 488 | 0.087375 | 0.081375 | 0.076109 | 0.071466 | 0.067352 | 0.063692 | 0.060421 |
| 490 | 0.081019 | 0.076457 | 0.072431 | 0.068863 | 0.065685 | 0.062844 | 0.060291 |
| 492 | 0.07552 | 0.072196 | 0.069243 | 0.066608 | 0.064246 | 0.062121 | 0.060202 |
| 494 | 0.070609 | 0.068316 | 0.066256 | 0.064399 | 0.06272 | 0.061197 | 0.059812 |
| 496 | 0.065799 | 0.064336 | 0.062995 | 0.061765 | 0.060635 | 0.059596 | 0.058638 |
| 498 | 0.061659 | 0.060887 | 0.06014 | 0.059423 | 0.058739 | 0.05809 | 0.057475 |
| 500 | 0.058438 | 0.058262 | 0.058023 | 0.057743 | 0.057435 | 0.057113 | 0.056783 |
| 502 | 0.055844 | 0.056184 | 0.056386 | 0.056483 | 0.0565 | 0.056459 | 0.056374 |
| 504 | 0.053829 | 0.054613 | 0.055192 | 0.055609 | 0.055902 | 0.056099 | 0.056222 |
| 506 | 0.052576 | 0.053758 | 0.054672 | 0.055375 | 0.055911 | 0.056316 | 0.056619 |
| 508 | 0.051836 | 0.053379 | 0.054595 | 0.055553 | 0.056306 | 0.056896 | 0.057357 |
| 510 | 0.051806 | 0.053684 | 0.05518 | 0.056372 | 0.057322 | 0.05808 | 0.058683 |
| 512 | 0.0518 | 0.053965 | 0.0557 | 0.057093 | 0.058212 | 0.059112 | 0.059837 |
| 514 | 0.052268 | 0.054707 | 0.05667 | 0.058252 | 0.059529 | 0.060563 | 0.061401 |
| 516 | 0.052955 | 0.055644 | 0.057812 | 0.059565 | 0.060986 | 0.062139 | 0.063078 |
| 518 | 0.05377 | 0.056692 | 0.059053 | 0.060965 | 0.062518 | 0.063782 | 0.064814 |
| 520 | 0.055031 | 0.058175 | 0.060718 | 0.062781 | 0.064458 | 0.065826 | 0.066945 |
| 522 | 0.05628 | 0.059632 | 0.062346 | 0.064549 | 0.066343 | 0.067807 | 0.069006 |
| 524 | 0.057724 | 0.061278 | 0.064158 | 0.066497 | 0.068403 | 0.06996 | 0.071237 |
| 526 | 0.059121 | 0.062857 | 0.065886 | 0.068348 | 0.070354 | 0.071995 | 0.073341 |
| 528 | 0.060763 | 0.064686 | 0.067866 | 0.070452 | 0.072561 | 0.074286 | 0.075702 |
| 530 | 0.06252 | 0.066619 | 0.069945 | 0.07265 | 0.074856 | 0.076661 | 0.078144 |
| 532 | 0.064161 | 0.068431 | 0.071895 | 0.074712 | 0.077012 | 0.078893 | 0.080439 |
| 534 | 0.065775 | 0.070213 | 0.073814 | 0.076744 | 0.079134 | 0.081092 | 0.082699 |
| 536 | 0.067617 | 0.072226 | 0.075966 | 0.079009 | 0.081493 | 0.083527 | 0.085198 |
| 538 | 0.069445 | 0.074218 | 0.078091 | 0.081243 | 0.083816 | 0.085923 | 0.087654 |
| 540 | 0.071154 | 0.076077 | 0.080073 | 0.083324 | 0.085979 | 0.088152 | 0.089939 |
| 542 | 0.072996 | 0.078079 | 0.082205 | 0.085562 | 0.088303 | 0.090548 | 0.092392 |
| 544 | 0.074729 | 0.07997 | 0.084224 | 0.087687 | 0.090514 | 0.092829 | 0.094732 |
| 546 | 0.076546 | 0.081936 | 0.08631 | 0.089871 | 0.092777 | 0.095158 | 0.097115 |
| 548 | 0.078323 | 0.08386 | 0.088355 | 0.092013 | 0.095 | 0.097446 | 0.099457 |
| 550 | 0.080187 | 0.085877 | 0.090495 | 0.094255 | 0.097324 | 0.099837 | 0.101904 |
| 552 | 0.082147 | 0.087993 | 0.092738 | 0.096601 | 0.099754 | 0.102338 | 0.104461 |
| 554 | 0.083875 | 0.08986 | 0.094717 | 0.098671 | 0.1019 | 0.104544 | 0.106717 |
| 556 | 0.085662 | 0.091789 | 0.096762 | 0.10081 | 0.104116 | 0.106823 | 0.109048 |
| 558 | 0.087408 | 0.093673 | 0.098759 | 0.102898 | 0.106278 | 0.109046 | 0.111322 |
| 560 | 0.088929 | 0.095322 | 0.10051 | 0.104734 | 0.108182 | 0.111007 | 0.113329 |
| 562 | 0.090505 | 0.097017 | 0.102302 | 0.106604 | 0.110117 | 0.112994 | 0.115359 |
| 564 | 0.091986 | 0.098609 | 0.103985 | 0.108361 | 0.111934 | 0.114861 | 0.117266 |
| 566 | 0.093393 | 0.100127 | 0.105594 | 0.110043 | 0.113676 | 0.116652 | 0.119098 |
| 568 | 0.094706 | 0.101537 | 0.107082 | 0.111596 | 0.115281 | 0.1183 | 0.120781 |
| 570 | 0.095719 | 0.102627 | 0.108235 | 0.112799 | 0.116526 | 0.119579 | 0.122088 |
| 572 | 0.096585 | 0.103558 | 0.109217 | 0.113825 | 0.117586 | 0.120668 | 0.1232 |
| 574 | 0.097316 | 0.104344 | 0.11005 | 0.114694 | 0.118485 | 0.121591 | 0.124144 |
| 576 | 0.097962 | 0.10504 | 0.110784 | 0.11546 | 0.119278 | 0.122406 | 0.124977 |
| 578 | 0.098175 | 0.105267 | 0.111024 | 0.115711 | 0.119537 | 0.122671 | 0.125248 |
| 580 | 0.098344 | 0.105442 | 0.111204 | 0.115895 | 0.119724 | 0.122861 | 0.12544 |
| 582 | 0.098483 | 0.105589 | 0.111357 | 0.116052 | 0.119886 | 0.123026 | 0.125608 |
| 584 | 0.098695 | 0.105799 | 0.111566 | 0.11626 | 0.120093 | 0.123232 | 0.125813 |
| 586 | 0.098657 | 0.105746 | 0.111501 | 0.116185 | 0.12001 | 0.123143 | 0.125718 |
| 588 | 0.098166 | 0.105209 | 0.110926 | 0.11558 | 0.11938 | 0.122493 | 0.125051 |
| 590 | 0.097772 | 0.104776 | 0.110461 | 0.115088 | 0.118866 | 0.121961 | 0.124505 |
| 592 | 0.097204 | 0.104154 | 0.109795 | 0.114387 | 0.118136 | 0.121207 | 0.123731 |
| 594 | 0.096622 | 0.103514 | 0.109108 | 0.113662 | 0.11738 | 0.120425 | 0.122929 |
| 596 | 0.095698 | 0.102517 | 0.108053 | 0.112559 | 0.116237 | 0.119251 | 0.121728 |
| 598 | 0.094598 | 0.10134 | 0.106812 | 0.111266 | 0.114903 | 0.117882 | 0.120331 |
| 600 | 0.093479 | 0.10014 | 0.105546 | 0.109947 | 0.113541 | 0.116484 | 0.118904 |
| 602 | 0.092331 | 0.098908 | 0.104246 | 0.108591 | 0.112139 | 0.115045 | 0.117434 |
| 604 | 0.091127 | 0.097612 | 0.102877 | 0.107162 | 0.11066 | 0.113526 | 0.115882 |
| 606 | 0.089721 | 0.0961 | 0.101279 | 0.105494 | 0.108935 | 0.111754 | 0.114072 |
| 608 | 0.088177 | 0.094441 | 0.099526 | 0.103665 | 0.107045 | 0.109813 | 0.112089 |
| 610 | 0.086486 | 0.092624 | 0.097607 | 0.101663 | 0.104974 | 0.107687 | 0.109916 |
| 612 | 0.084667 | 0.090677 | 0.095555 | 0.099526 | 0.102768 | 0.105424 | 0.107607 |
| 614 | 0.082879 | 0.088759 | 0.093531 | 0.097416 | 0.100588 | 0.103187 | 0.105322 |
| 616 | 0.080843 | 0.086577 | 0.091231 | 0.09502 | 0.098113 | 0.100647 | 0.102729 |
| 618 | 0.078582 | 0.084157 | 0.088681 | 0.092365 | 0.095372 | 0.097836 | 0.099861 |
| 620 | 0.076559 | 0.081994 | 0.086406 | 0.089997 | 0.092929 | 0.095331 | 0.097305 |
| 622 | 0.074611 | 0.079907 | 0.084206 | 0.087705 | 0.090562 | 0.092903 | 0.094826 |
| 624 | 0.07244 | 0.077588 | 0.081768 | 0.085169 | 0.087947 | 0.090222 | 0.092092 |
| 626 | 0.070202 | 0.075197 | 0.079252 | 0.082552 | 0.085247 | 0.087455 | 0.089269 |
| 628 | 0.068086 | 0.072943 | 0.076885 | 0.080095 | 0.082715 | 0.084861 | 0.086626 |
| 630 | 0.066322 | 0.071065 | 0.074914 | 0.078048 | 0.080606 | 0.082702 | 0.084425 |
| 632 | 0.064473 | 0.06909 | 0.072837 | 0.075888 | 0.078378 | 0.080418 | 0.082095 |
| 634 | 0.062313 | 0.066789 | 0.070422 | 0.07338 | 0.075795 | 0.077772 | 0.079398 |
| 636 | 0.060573 | 0.064929 | 0.068464 | 0.071342 | 0.073692 | 0.075617 | 0.077199 |
| 638 | 0.058594 | 0.062811 | 0.066233 | 0.06902 | 0.071294 | 0.073158 | 0.074689 |
| 640 | 0.056926 | 0.061026 | 0.064353 | 0.067062 | 0.069273 | 0.071085 | 0.072574 |
| 642 | 0.055124 | 0.059096 | 0.06232 | 0.064944 | 0.067087 | 0.068842 | 0.070285 |
| 644 | 0.053362 | 0.057212 | 0.060337 | 0.062881 | 0.064958 | 0.066659 | 0.068058 |
| 646 | 0.051861 | 0.055605 | 0.058644 | 0.061118 | 0.063137 | 0.064792 | 0.066152 |
| 648 | 0.050375 | 0.054012 | 0.056964 | 0.059367 | 0.061329 | 0.062937 | 0.064258 |
| 650 | 0.049017 | 0.052562 | 0.055439 | 0.057781 | 0.059694 | 0.06126 | 0.062548 |
| 652 | 0.047449 | 0.050872 | 0.053651 | 0.055913 | 0.05776 | 0.059273 | 0.060517 |
| 654 | 0.045831 | 0.049145 | 0.051836 | 0.054026 | 0.055814 | 0.057279 | 0.058483 |
| 656 | 0.044377 | 0.047592 | 0.050201 | 0.052325 | 0.05406 | 0.05548 | 0.056648 |
| 658 | 0.043038 | 0.046155 | 0.048685 | 0.050745 | 0.052427 | 0.053804 | 0.054936 |
| 660 | 0.041739 | 0.044762 | 0.047215 | 0.049212 | 0.050843 | 0.052179 | 0.053277 |
| 662 | 0.040519 | 0.043445 | 0.04582 | 0.047753 | 0.049331 | 0.050624 | 0.051687 |
| 664 | 0.03941 | 0.042263 | 0.044579 | 0.046464 | 0.048003 | 0.049264 | 0.0503 |
| 666 | 0.038212 | 0.040977 | 0.043222 | 0.04505 | 0.046542 | 0.047764 | 0.048769 |
| 668 | 0.036935 | 0.039606 | 0.041775 | 0.04354 | 0.044981 | 0.046162 | 0.047132 |
| 670 | 0.035775 | 0.038361 | 0.04046 | 0.042169 | 0.043564 | 0.044706 | 0.045646 |
| 672 | 0.034349 | 0.03683 | 0.038844 | 0.040484 | 0.041822 | 0.042918 | 0.04382 |
| 674 | 0.0331 | 0.035486 | 0.037422 | 0.038998 | 0.040285 | 0.041339 | 0.042205 |
| 676 | 0.0319 | 0.034195 | 0.036058 | 0.037575 | 0.038814 | 0.039828 | 0.040662 |
| 678 | 0.030757 | 0.032969 | 0.034764 | 0.036225 | 0.037418 | 0.038395 | 0.039199 |
| 680 | 0.029783 | 0.031923 | 0.03366 | 0.035074 | 0.036229 | 0.037174 | 0.037952 |
| 682 | 0.028968 | 0.031042 | 0.032725 | 0.034095 | 0.035214 | 0.036131 | 0.036884 |
| 684 | 0.028388 | 0.030411 | 0.032053 | 0.03339 | 0.034481 | 0.035375 | 0.03611 |
| 686 | 0.027655 | 0.029629 | 0.031232 | 0.032536 | 0.033602 | 0.034474 | 0.035191 |
| 688 | 0.026923 | 0.028844 | 0.030404 | 0.031673 | 0.03271 | 0.033559 | 0.034257 |
| 690 | 0.026251 | 0.028123 | 0.029642 | 0.030879 | 0.031888 | 0.032715 | 0.033395 |
| 692 | 0.025258 | 0.027056 | 0.028515 | 0.029703 | 0.030673 | 0.031467 | 0.03212 |
| 694 | 0.024266 | 0.026 | 0.027406 | 0.028552 | 0.029487 | 0.030253 | 0.030882 |
| 696 | 0.023366 | 0.02503 | 0.02638 | 0.027479 | 0.028377 | 0.029112 | 0.029716 |
| 698 | 0.02259 | 0.0242 | 0.025506 | 0.02657 | 0.027438 | 0.02815 | 0.028734 |
| 700 | 0.021861 | 0.023423 | 0.02469 | 0.025722 | 0.026564 | 0.027254 | 0.027821 |
| 702 | 0.021054 | 0.022554 | 0.023771 | 0.024762 | 0.025572 | 0.026234 | 0.026779 |
| 704 | 0.020684 | 0.022157 | 0.023352 | 0.024325 | 0.02512 | 0.025771 | 0.026306 |
| 706 | 0.020257 | 0.021697 | 0.022865 | 0.023816 | 0.024592 | 0.025228 | 0.025751 |
| 708 | 0.019725 | 0.021136 | 0.022281 | 0.023213 | 0.023974 | 0.024598 | 0.025111 |
| 710 | 0.019004 | 0.020366 | 0.021471 | 0.02237 | 0.023105 | 0.023706 | 0.024201 |
| 712 | 0.018459 | 0.019776 | 0.020846 | 0.021716 | 0.022427 | 0.023009 | 0.023488 |
| 714 | 0.017863 | 0.01914 | 0.020177 | 0.021021 | 0.02171 | 0.022274 | 0.022738 |
| 716 | 0.017256 | 0.01849 | 0.019492 | 0.020307 | 0.020973 | 0.021518 | 0.021966 |
| 718 | 0.016515 | 0.017685 | 0.018635 | 0.019408 | 0.020039 | 0.020556 | 0.020981 |
| 720 | 0.015769 | 0.016876 | 0.017774 | 0.018505 | 0.019102 | 0.019591 | 0.019993 |
| 722 | 0.01567 | 0.016767 | 0.017658 | 0.018383 | 0.018975 | 0.01946 | 0.019858 |
| 724 | 0.015086 | 0.01614 | 0.016995 | 0.017691 | 0.018259 | 0.018725 | 0.019108 |
| 726 | 0.014586 | 0.015599 | 0.016422 | 0.017091 | 0.017638 | 0.018086 | 0.018454 |
| 728 | 0.013796 | 0.01474 | 0.015506 | 0.01613 | 0.016639 | 0.017056 | 0.017399 |
| 730 | 0.013886 | 0.014823 | 0.015584 | 0.016204 | 0.016709 | 0.017123 | 0.017464 |
| 732 | 0.01374 | 0.01467 | 0.015425 | 0.01604 | 0.016541 | 0.016952 | 0.01729 |
| 734 | 0.012942 | 0.01381 | 0.014514 | 0.015087 | 0.015555 | 0.015938 | 0.016253 |
| 736 | 0.01249 | 0.013327 | 0.014006 | 0.014559 | 0.01501 | 0.01538 | 0.015684 |
| 738 | 0.012483 | 0.013319 | 0.013998 | 0.01455 | 0.015002 | 0.015371 | 0.015675 |
| 740 | 0.012586 | 0.013436 | 0.014126 | 0.014688 | 0.015146 | 0.015522 | 0.015831 |
| 742 | 0.011681 | 0.01248 | 0.013128 | 0.013656 | 0.014087 | 0.01444 | 0.01473 |
| 744 | 0.011396 | 0.012173 | 0.012804 | 0.013318 | 0.013737 | 0.01408 | 0.014363 |
| 746 | 0.011286 | 0.012057 | 0.012683 | 0.013192 | 0.013608 | 0.013949 | 0.014229 |
| 748 | 0.011499 | 0.012287 | 0.012927 | 0.013448 | 0.013874 | 0.014222 | 0.014509 |
| 750 | 0.011275 | 0.012049 | 0.012678 | 0.013189 | 0.013607 | 0.013949 | 0.014231 |
| 752 | 0.011176 | 0.011937 | 0.012555 | 0.013059 | 0.013469 | 0.013806 | 0.014083 |
| 754 | 0.010946 | 0.011699 | 0.012309 | 0.012806 | 0.013212 | 0.013545 | 0.013818 |
| 756 | 0.010821 | 0.011573 | 0.012183 | 0.01268 | 0.013086 | 0.013418 | 0.013691 |
| 758 | 0.010991 | 0.011761 | 0.012386 | 0.012895 | 0.01331 | 0.01365 | 0.01393 |
| 760 | 0.010552 | 0.011284 | 0.011879 | 0.012363 | 0.012759 | 0.013083 | 0.013349 |
| 762 | 0.010427 | 0.01112 | 0.011683 | 0.012142 | 0.012516 | 0.012822 | 0.013074 |
| 764 | 0.009795 | 0.010441 | 0.010965 | 0.011392 | 0.01174 | 0.012026 | 0.01226 |
| 766 | 0.009581 | 0.010211 | 0.010723 | 0.011139 | 0.011479 | 0.011758 | 0.011987 |
| 768 | 0.009419 | 0.010034 | 0.010534 | 0.01094 | 0.011272 | 0.011544 | 0.011768 |
| 770 | 0.008931 | 0.009507 | 0.009974 | 0.010354 | 0.010665 | 0.010919 | 0.011128 |
| 772 | 0.008704 | 0.009259 | 0.009709 | 0.010076 | 0.010375 | 0.01062 | 0.010822 |
| 774 | 0.008337 | 0.008892 | 0.009342 | 0.009709 | 0.010008 | 0.010254 | 0.010455 |
| 776 | 0.008563 | 0.009144 | 0.009615 | 0.009999 | 0.010312 | 0.010569 | 0.010779 |
| 778 | 0.008829 | 0.009427 | 0.009912 | 0.010307 | 0.010629 | 0.010893 | 0.01111 |
| 780 | 0.008616 | 0.009194 | 0.009664 | 0.010046 | 0.010358 | 0.010613 | 0.010824 |

TABLE IV
Chromaticity data and CRI for emission spectra shown in FIGS. 7 and 8.

| | CCT [K] | | | | | | |
|---|---|---|---|---|---|---|---|
| | 6133 | 4987 | 4409 | 4070 | 3850 | 3700 | 3592 |
| Ra | 82 | 82 | 81 | 79 | 77 | 75 | 74 |
| Δuv | 0.018 | 0.008 | 0.001 | 0.003 | 0.008 | 0.012 | 0.015 |
| x | 0.3218 | 0.3439 | 0.3632 | 0.3799 | 0.3942 | 0.4063 | 0.4166 |
| y | 0.3043 | 0.335 | 0.3616 | 0.3846 | 0.4041 | 0.4205 | 0.4343 |
| LE | 267 | 285 | 300 | 312 | 323 | 331 | 338 |
| MW | 551 | 559 | 565 | 570 | 574 | 578 | 581 |
| [nm] | | | | | | | |
| | T [μm] of the ceramic SiAlON garnet material | | | | | | |
| | 190 | 220 | 250 | 280 | 310 | 350 | 440 |
| R1 | 90.1 | 86.9 | 81.6 | 77.3 | 73.9 | 71.3 | 69.3 |
| R2 | 88.1 | 95.9 | 97.8 | 93.6 | 90.1 | 87.3 | 85 |
| R3 | 83.5 | 85 | 87.6 | 90.1 | 92.2 | 93.8 | 94.6 |
| R4 | 73 | 70 | 69 | 67.8 | 66.6 | 65.5 | 64.3 |
| R5 | 84.3 | 83 | 79.8 | 76.2 | 73.1 | 70.5 | 68.3 |
| R6 | 82.8 | 89.4 | 91 | 88.9 | 85.8 | 82.8 | 80.2 |
| R7 | 77.4 | 77.2 | 78.1 | 79 | 79.8 | 80.5 | 80.9 |
| R8 | 75.1 | 66.1 | 60.3 | 56.2 | 53.3 | 51.2 | 49.6 |
| R9 | 59.9 | 29.1 | 9.8 | −3.6 | −13.3 | −20.4 | −25.8 |
| R10 | 82.6 | 96.2 | 91.4 | 83.1 | 76.4 | 70.9 | 66.4 |
| R11 | 69.6 | 66.1 | 64.4 | 62.7 | 61.2 | 59.8 | 58.3 |
| R12 | 63.8 | 64 | 65.2 | 63.5 | 60.5 | 57.1 | 53.9 |
| R13 | 92.4 | 93.3 | 87 | 82 | 78.1 | 75.1 | 72.7 |
| R14 | 92.9 | 92.8 | 93.7 | 94.6 | 95.4 | 96.1 | 96.5 |

TABLE V
Emission data of the LEDs according to FIGS. 9 and 10

| | CCT | CCT | CCT | CCT | CCT | CCT | CCT |
|---|---|---|---|---|---|---|---|
| nm | 2726 K | 2672 K | 2631 K | 2599 K | 2574 K | 2554 K | 2538 K |
| 380 | 0.005935 | 0.005929 | 0.005924 | 0.00592 | 0.005916 | 0.005914 | 0.005911 |
| 382 | 0.006082 | 0.006071 | 0.006061 | 0.006052 | 0.006043 | 0.006036 | 0.006029 |
| 384 | 0.006975 | 0.006923 | 0.006875 | 0.006828 | 0.006784 | 0.006742 | 0.006702 |
| 386 | 0.004751 | 0.004698 | 0.004649 | 0.004601 | 0.004556 | 0.004514 | 0.004473 |
| 388 | 0.003249 | 0.003195 | 0.003145 | 0.003097 | 0.003051 | 0.003007 | 0.002965 |
| 390 | 0.003213 | 0.00316 | 0.003109 | 0.00306 | 0.003014 | 0.00297 | 0.002928 |
| 392 | 0.00324 | 0.003172 | 0.003108 | 0.003046 | 0.002987 | 0.002931 | 0.002877 |
| 394 | 0.00327 | 0.003186 | 0.003107 | 0.003032 | 0.002959 | 0.00289 | 0.002823 |
| 396 | 0.002256 | 0.002195 | 0.002137 | 0.002081 | 0.002028 | 0.001977 | 0.001929 |
| 398 | 0.002215 | 0.002147 | 0.002081 | 0.002019 | 0.00196 | 0.001903 | 0.001848 |
| 400 | 0.002095 | 0.002026 | 0.00196 | 0.001898 | 0.001838 | 0.00178 | 0.001726 |
| 402 | 0.002399 | 0.002315 | 0.002234 | 0.002157 | 0.002083 | 0.002013 | 0.001945 |
| 404 | 0.002905 | 0.002799 | 0.002698 | 0.002601 | 0.002508 | 0.002418 | 0.002333 |
| 406 | 0.003096 | 0.00298 | 0.002869 | 0.002763 | 0.002661 | 0.002563 | 0.002469 |
| 408 | 0.003454 | 0.003321 | 0.003195 | 0.003073 | 0.002956 | 0.002844 | 0.002736 |
| 410 | 0.004208 | 0.004039 | 0.003877 | 0.003722 | 0.003573 | 0.003431 | 0.003294 |
| 412 | 0.005832 | 0.005581 | 0.005341 | 0.005112 | 0.004893 | 0.004684 | 0.004483 |
| 414 | 0.007376 | 0.007028 | 0.006697 | 0.006382 | 0.006083 | 0.005797 | 0.005526 |
| 416 | 0.008909 | 0.008435 | 0.007988 | 0.007565 | 0.007166 | 0.006787 | 0.00643 |
| 418 | 0.011108 | 0.010452 | 0.009835 | 0.009256 | 0.008713 | 0.008202 | 0.007722 |
| 420 | 0.014359 | 0.013416 | 0.012537 | 0.011718 | 0.010955 | 0.010244 | 0.009581 |
| 422 | 0.017892 | 0.016575 | 0.01536 | 0.014239 | 0.013204 | 0.012247 | 0.011363 |
| 424 | 0.02162 | 0.019832 | 0.0182 | 0.01671 | 0.015347 | 0.014102 | 0.012962 |
| 426 | 0.025827 | 0.023448 | 0.0213 | 0.019359 | 0.017603 | 0.016015 | 0.014578 |
| 428 | 0.030169 | 0.027096 | 0.024352 | 0.021901 | 0.01971 | 0.017749 | 0.015994 |
| 430 | 0.0348 | 0.030906 | 0.02747 | 0.024436 | 0.021754 | 0.019383 | 0.017283 |
| 432 | 0.039202 | 0.034404 | 0.030222 | 0.026574 | 0.023389 | 0.020605 | 0.018169 |
| 434 | 0.043383 | 0.037612 | 0.032646 | 0.028366 | 0.024675 | 0.021487 | 0.018732 |
| 436 | 0.046855 | 0.040128 | 0.03441 | 0.029544 | 0.025397 | 0.021859 | 0.018837 |
| 438 | 0.049737 | 0.042079 | 0.035649 | 0.030243 | 0.025691 | 0.021854 | 0.018615 |
| 440 | 0.052128 | 0.043592 | 0.036506 | 0.030616 | 0.025713 | 0.021627 | 0.018216 |
| 442 | 0.053519 | 0.044263 | 0.036661 | 0.03041 | 0.025263 | 0.021018 | 0.017512 |
| 444 | 0.053795 | 0.044036 | 0.0361 | 0.029638 | 0.024369 | 0.020066 | 0.016547 |
| 446 | 0.052949 | 0.04295 | 0.034888 | 0.028379 | 0.023117 | 0.018858 | 0.015404 |
| 448 | 0.051218 | 0.041227 | 0.033227 | 0.026815 | 0.021668 | 0.017531 | 0.014201 |
| 450 | 0.048575 | 0.03885 | 0.031107 | 0.024935 | 0.020011 | 0.016076 | 0.012928 |
| 452 | 0.045254 | 0.036012 | 0.028684 | 0.022869 | 0.018249 | 0.014574 | 0.011648 |
| 454 | 0.041618 | 0.033001 | 0.026187 | 0.020795 | 0.016523 | 0.013136 | 0.010447 |
| 456 | 0.037976 | 0.030053 | 0.023796 | 0.018849 | 0.014936 | 0.011837 | 0.009381 |
| 458 | 0.034596 | 0.02737 | 0.021659 | 0.017144 | 0.01357 | 0.01074 | 0.008496 |
| 460 | 0.031736 | 0.025147 | 0.01993 | 0.015795 | 0.012516 | 0.009913 | 0.007846 |
| 462 | 0.029354 | 0.023345 | 0.018568 | 0.014767 | 0.011741 | 0.00933 | 0.007408 |
| 464 | 0.027377 | 0.021897 | 0.017518 | 0.014014 | 0.011208 | 0.00896 | 0.007157 |
| 466 | 0.025786 | 0.020785 | 0.016761 | 0.013519 | 0.010904 | 0.008793 | 0.007086 |
| 468 | 0.024633 | 0.020077 | 0.016381 | 0.013379 | 0.010937 | 0.008947 | 0.007323 |
| 470 | 0.02381 | 0.019668 | 0.016277 | 0.013496 | 0.011211 | 0.00933 | 0.007779 |
| 472 | 0.023295 | 0.019557 | 0.016465 | 0.013903 | 0.011775 | 0.010003 | 0.008525 |
| 474 | 0.022841 | 0.019487 | 0.016684 | 0.014336 | 0.012363 | 0.010702 | 0.009299 |
| 476 | 0.02255 | 0.019578 | 0.017068 | 0.014943 | 0.013137 | 0.011598 | 0.010283 |
| 478 | 0.022466 | 0.019855 | 0.017628 | 0.015722 | 0.014084 | 0.012672 | 0.01145 |
| 480 | 0.022372 | 0.020098 | 0.018139 | 0.016444 | 0.014971 | 0.013688 | 0.012566 |
| 482 | 0.022446 | 0.020502 | 0.01881 | 0.017332 | 0.016035 | 0.014892 | 0.013882 |
| 484 | 0.022436 | 0.020812 | 0.019388 | 0.018133 | 0.017022 | 0.016034 | 0.015152 |
| 486 | 0.022407 | 0.021092 | 0.01993 | 0.018899 | 0.017979 | 0.017155 | 0.016414 |
| 488 | 0.022312 | 0.021266 | 0.020335 | 0.019503 | 0.018757 | 0.018084 | 0.017475 |
| 490 | 0.022451 | 0.021643 | 0.02092 | 0.02027 | 0.019683 | 0.01915 | 0.018665 |
| 492 | 0.022865 | 0.022269 | 0.021733 | 0.021248 | 0.020807 | 0.020404 | 0.020036 |
| 494 | 0.023031 | 0.022621 | 0.022248 | 0.021908 | 0.021597 | 0.02131 | 0.021046 |
| 496 | 0.023027 | 0.022766 | 0.022524 | 0.0223 | 0.022092 | 0.021898 | 0.021718 |
| 498 | 0.023182 | 0.023039 | 0.0229 | 0.022766 | 0.022638 | 0.022515 | 0.022398 |
| 500 | 0.023793 | 0.023749 | 0.023697 | 0.023639 | 0.023576 | 0.023512 | 0.023446 |
| 502 | 0.02465 | 0.024695 | 0.024719 | 0.024727 | 0.024723 | 0.02471 | 0.02469 |
| 504 | 0.025256 | 0.025379 | 0.02547 | 0.025536 | 0.025583 | 0.025614 | 0.025634 |
| 506 | 0.026085 | 0.026274 | 0.026421 | 0.026537 | 0.026626 | 0.026695 | 0.026747 |
| 508 | 0.027243 | 0.027492 | 0.027692 | 0.027852 | 0.02798 | 0.028082 | 0.028163 |
| 510 | 0.028797 | 0.029101 | 0.029347 | 0.029547 | 0.029709 | 0.02984 | 0.029947 |
| 512 | 0.030651 | 0.031008 | 0.031298 | 0.031535 | 0.031729 | 0.031889 | 0.032019 |
| 514 | 0.032182 | 0.032587 | 0.032918 | 0.03319 | 0.033414 | 0.033598 | 0.033751 |
| 516 | 0.033932 | 0.034383 | 0.034754 | 0.035059 | 0.035311 | 0.035519 | 0.035693 |
| 518 | 0.035551 | 0.036045 | 0.036452 | 0.036788 | 0.037065 | 0.037295 | 0.037487 |
| 520 | 0.037585 | 0.038123 | 0.038565 | 0.038931 | 0.039234 | 0.039485 | 0.039695 |
| 522 | 0.039712 | 0.040291 | 0.040768 | 0.041163 | 0.04149 | 0.041762 | 0.04199 |
| 524 | 0.041122 | 0.04174 | 0.042249 | 0.042671 | 0.04302 | 0.043312 | 0.043555 |
| 526 | 0.042683 | 0.043338 | 0.043879 | 0.044326 | 0.044697 | 0.045006 | 0.045265 |
| 528 | 0.044232 | 0.044923 | 0.045493 | 0.045965 | 0.046357 | 0.046684 | 0.046958 |
| 530 | 0.046169 | 0.046897 | 0.047499 | 0.047997 | 0.048411 | 0.048756 | 0.049045 |
| 532 | 0.048032 | 0.048797 | 0.049428 | 0.04995 | 0.050385 | 0.050747 | 0.05105 |
| 534 | 0.049727 | 0.050529 | 0.05119 | 0.051738 | 0.052193 | 0.052573 | 0.052892 |
| 536 | 0.051883 | 0.052723 | 0.053417 | 0.053992 | 0.05447 | 0.054869 | 0.055203 |
| 538 | 0.054076 | 0.054956 | 0.055683 | 0.056285 | 0.056786 | 0.057204 | 0.057554 |
| 540 | 0.056279 | 0.057199 | 0.057958 | 0.058588 | 0.059111 | 0.059548 | 0.059914 |
| 542 | 0.058656 | 0.059617 | 0.060412 | 0.06107 | 0.061617 | 0.062074 | 0.062457 |
| 544 | 0.061111 | 0.062117 | 0.062947 | 0.063635 | 0.064207 | 0.064685 | 0.065085 |
| 546 | 0.063452 | 0.064501 | 0.065367 | 0.066085 | 0.066681 | 0.06718 | 0.067597 |
| 548 | 0.066041 | 0.067135 | 0.068039 | 0.068789 | 0.069412 | 0.069932 | 0.070368 |
| 550 | 0.068534 | 0.069675 | 0.070617 | 0.071398 | 0.072047 | 0.072589 | 0.073044 |
| 552 | 0.071385 | 0.072575 | 0.073559 | 0.074373 | 0.075051 | 0.075617 | 0.076091 |
| 554 | 0.07456 | 0.075801 | 0.076826 | 0.077676 | 0.078382 | 0.078972 | 0.079466 |
| 556 | 0.077421 | 0.078712 | 0.079778 | 0.080661 | 0.081395 | 0.082009 | 0.082523 |
| 558 | 0.080508 | 0.081852 | 0.082961 | 0.08388 | 0.084645 | 0.085283 | 0.085818 |
| 560 | 0.083358 | 0.084752 | 0.085904 | 0.086858 | 0.087651 | 0.088314 | 0.088869 |
| 562 | 0.086319 | 0.087764 | 0.088956 | 0.089945 | 0.090767 | 0.091453 | 0.092029 |
| 564 | 0.089373 | 0.090867 | 0.092101 | 0.093123 | 0.093973 | 0.094683 | 0.095278 |
| 566 | 0.091923 | 0.093463 | 0.094734 | 0.095788 | 0.096664 | 0.097396 | 0.098009 |
| 568 | 0.09436 | 0.095943 | 0.097251 | 0.098335 | 0.099236 | 0.099989 | 0.10062 |
| 570 | 0.097133 | 0.098762 | 0.100107 | 0.101221 | 0.102148 | 0.102922 | 0.103571 |
| 572 | 0.099655 | 0.101325 | 0.102704 | 0.103847 | 0.104797 | 0.105591 | 0.106256 |
| 574 | 0.102 | 0.10371 | 0.105121 | 0.106291 | 0.107264 | 0.108077 | 0.108758 |
| 576 | 0.104195 | 0.105943 | 0.107386 | 0.108583 | 0.109578 | 0.110408 | 0.111104 |
| 578 | 0.106159 | 0.107944 | 0.109417 | 0.110639 | 0.111654 | 0.112502 | 0.113213 |
| 580 | 0.108282 | 0.110101 | 0.111603 | 0.112848 | 0.113883 | 0.114748 | 0.115472 |
| 582 | 0.110052 | 0.111901 | 0.113428 | 0.114693 | 0.115746 | 0.116625 | 0.117361 |
| 584 | 0.111625 | 0.113502 | 0.115052 | 0.116337 | 0.117405 | 0.118297 | 0.119045 |
| 586 | 0.113251 | 0.11515 | 0.116719 | 0.118018 | 0.1191 | 0.120002 | 0.120759 |
| 588 | 0.114382 | 0.116298 | 0.117881 | 0.119192 | 0.120283 | 0.121194 | 0.121957 |
| 590 | 0.1157 | 0.117634 | 0.119231 | 0.120555 | 0.121656 | 0.122575 | 0.123345 |
| 592 | 0.116554 | 0.1185 | 0.120107 | 0.121439 | 0.122547 | 0.123472 | 0.124247 |
| 594 | 0.117117 | 0.11907 | 0.120684 | 0.122021 | 0.123132 | 0.124061 | 0.124839 |
| 596 | 0.117806 | 0.119765 | 0.121383 | 0.122724 | 0.123839 | 0.12477 | 0.12555 |
| 598 | 0.118112 | 0.120076 | 0.121698 | 0.123042 | 0.12416 | 0.125094 | 0.125876 |
| 600 | 0.118249 | 0.120215 | 0.12184 | 0.123185 | 0.124305 | 0.12524 | 0.126023 |
| 602 | 0.117779 | 0.11974 | 0.12136 | 0.122702 | 0.123818 | 0.12475 | 0.125532 |
| 604 | 0.117344 | 0.119299 | 0.120914 | 0.122253 | 0.123366 | 0.124295 | 0.125074 |
| 606 | 0.116561 | 0.118506 | 0.120112 | 0.121443 | 0.12255 | 0.123475 | 0.124249 |
| 608 | 0.115687 | 0.117617 | 0.119211 | 0.120531 | 0.12163 | 0.122547 | 0.123316 |
| 610 | 0.114474 | 0.116384 | 0.117961 | 0.119269 | 0.120356 | 0.121263 | 0.122024 |
| 612 | 0.113159 | 0.115047 | 0.116606 | 0.117897 | 0.118972 | 0.119869 | 0.120621 |
| 614 | 0.111748 | 0.113613 | 0.115153 | 0.116429 | 0.117491 | 0.118377 | 0.11912 |
| 616 | 0.109881 | 0.111717 | 0.113232 | 0.114489 | 0.115534 | 0.116406 | 0.117137 |
| 618 | 0.108147 | 0.109954 | 0.111446 | 0.112683 | 0.113711 | 0.11457 | 0.11529 |
| 620 | 0.106254 | 0.108031 | 0.109499 | 0.110715 | 0.111726 | 0.112571 | 0.113279 |
| 622 | 0.104175 | 0.105921 | 0.107364 | 0.108559 | 0.109553 | 0.110383 | 0.111079 |
| 624 | 0.10196 | 0.103673 | 0.105089 | 0.106261 | 0.107237 | 0.108051 | 0.108734 |
| 626 | 0.099728 | 0.101405 | 0.102791 | 0.103939 | 0.104893 | 0.105691 | 0.106359 |
| 628 | 0.097758 | 0.099401 | 0.100758 | 0.101882 | 0.102817 | 0.103598 | 0.104252 |
| 630 | 0.095543 | 0.097151 | 0.098479 | 0.09958 | 0.100495 | 0.10126 | 0.1019 |
| 632 | 0.093004 | 0.094575 | 0.095872 | 0.096947 | 0.097841 | 0.098588 | 0.099213 |
| 634 | 0.090734 | 0.092268 | 0.093535 | 0.094584 | 0.095458 | 0.096187 | 0.096798 |
| 636 | 0.088644 | 0.090142 | 0.091379 | 0.092404 | 0.093256 | 0.093968 | 0.094565 |
| 638 | 0.086469 | 0.087931 | 0.089139 | 0.09014 | 0.090972 | 0.091667 | 0.092249 |
| 640 | 0.084395 | 0.085824 | 0.087004 | 0.087982 | 0.088796 | 0.089475 | 0.090045 |
| 642 | 0.082218 | 0.083611 | 0.084761 | 0.085715 | 0.086508 | 0.08717 | 0.087725 |
| 644 | 0.080255 | 0.081614 | 0.082736 | 0.083667 | 0.08444 | 0.085086 | 0.085628 |
| 646 | 0.078285 | 0.07961 | 0.080704 | 0.08161 | 0.082365 | 0.082994 | 0.083522 |
| 648 | 0.076241 | 0.077531 | 0.078596 | 0.079479 | 0.080214 | 0.080827 | 0.081341 |
| 650 | 0.074502 | 0.07576 | 0.076799 | 0.07766 | 0.078376 | 0.078974 | 0.079475 |
| 652 | 0.0725 | 0.073724 | 0.074736 | 0.075574 | 0.076271 | 0.076853 | 0.077341 |
| 654 | 0.070603 | 0.071794 | 0.072777 | 0.073592 | 0.07427 | 0.074836 | 0.07531 |
| 656 | 0.068709 | 0.069867 | 0.070823 | 0.071616 | 0.072275 | 0.072825 | 0.073287 |
| 658 | 0.06699 | 0.068117 | 0.069048 | 0.069819 | 0.07046 | 0.070996 | 0.071445 |
| 660 | 0.06536 | 0.066457 | 0.067363 | 0.068114 | 0.068739 | 0.06926 | 0.069697 |
| 662 | 0.063507 | 0.064574 | 0.065455 | 0.066185 | 0.066792 | 0.067299 | 0.067724 |
| 664 | 0.061809 | 0.062845 | 0.0637 | 0.06441 | 0.064999 | 0.065492 | 0.065904 |
| 666 | 0.060239 | 0.061249 | 0.062084 | 0.062775 | 0.063351 | 0.063831 | 0.064234 |
| 668 | 0.058602 | 0.059586 | 0.060399 | 0.061073 | 0.061633 | 0.062101 | 0.062493 |
| 670 | 0.056928 | 0.057885 | 0.058676 | 0.059332 | 0.059877 | 0.060332 | 0.060714 |
| 672 | 0.055265 | 0.056195 | 0.056963 | 0.057599 | 0.058128 | 0.05857 | 0.058941 |
| 674 | 0.053725 | 0.054627 | 0.055372 | 0.05599 | 0.056504 | 0.056933 | 0.057292 |
| 676 | 0.052129 | 0.053006 | 0.05373 | 0.054331 | 0.05483 | 0.055247 | 0.055596 |
| 678 | 0.050511 | 0.051361 | 0.052063 | 0.052645 | 0.053129 | 0.053533 | 0.053871 |
| 680 | 0.049338 | 0.050164 | 0.050847 | 0.051412 | 0.051883 | 0.052275 | 0.052605 |
| 682 | 0.048023 | 0.048826 | 0.049488 | 0.050037 | 0.050494 | 0.050876 | 0.051195 |
| 684 | 0.046928 | 0.047708 | 0.048351 | 0.048885 | 0.049328 | 0.049699 | 0.050009 |
| 686 | 0.045553 | 0.046311 | 0.046937 | 0.047456 | 0.047887 | 0.048247 | 0.048549 |
| 688 | 0.044356 | 0.045093 | 0.045702 | 0.046206 | 0.046625 | 0.046975 | 0.047269 |
| 690 | 0.043336 | 0.044054 | 0.044646 | 0.045137 | 0.045545 | 0.045886 | 0.046172 |
| 692 | 0.041946 | 0.042641 | 0.043216 | 0.043692 | 0.044088 | 0.044419 | 0.044696 |
| 694 | 0.041053 | 0.041731 | 0.04229 | 0.042754 | 0.04314 | 0.043462 | 0.043731 |
| 696 | 0.039598 | 0.040256 | 0.040799 | 0.041249 | 0.041623 | 0.041935 | 0.042197 |
| 698 | 0.038437 | 0.039075 | 0.039601 | 0.040038 | 0.040401 | 0.040704 | 0.040958 |
| 700 | 0.037362 | 0.037981 | 0.038493 | 0.038917 | 0.03927 | 0.039565 | 0.039811 |
| 702 | 0.036358 | 0.03696 | 0.037456 | 0.037868 | 0.03821 | 0.038496 | 0.038736 |
| 704 | 0.035681 | 0.036266 | 0.036749 | 0.03715 | 0.037482 | 0.03776 | 0.037993 |
| 706 | 0.034488 | 0.035056 | 0.035525 | 0.035914 | 0.036237 | 0.036507 | 0.036734 |
| 708 | 0.033577 | 0.034131 | 0.034588 | 0.034967 | 0.035283 | 0.035546 | 0.035767 |
| 710 | 0.032761 | 0.033301 | 0.033747 | 0.034116 | 0.034423 | 0.03468 | 0.034895 |
| 712 | 0.031859 | 0.032383 | 0.032816 | 0.033175 | 0.033473 | 0.033722 | 0.033931 |
| 714 | 0.031022 | 0.031531 | 0.031952 | 0.032301 | 0.032591 | 0.032833 | 0.033035 |
| 716 | 0.02996 | 0.030455 | 0.030864 | 0.031203 | 0.031485 | 0.031721 | 0.031918 |
| 718 | 0.028933 | 0.029412 | 0.029808 | 0.030136 | 0.030409 | 0.030636 | 0.030827 |
| 720 | 0.028136 | 0.0286 | 0.028984 | 0.029301 | 0.029565 | 0.029786 | 0.029971 |
| 722 | 0.027236 | 0.027685 | 0.028056 | 0.028363 | 0.028619 | 0.028832 | 0.029011 |
| 724 | 0.026686 | 0.027121 | 0.02748 | 0.027778 | 0.028026 | 0.028233 | 0.028406 |
| 726 | 0.026088 | 0.026509 | 0.026858 | 0.027147 | 0.027387 | 0.027588 | 0.027756 |
| 728 | 0.025255 | 0.025662 | 0.025998 | 0.026276 | 0.026508 | 0.026702 | 0.026864 |
| 730 | 0.024746 | 0.025142 | 0.025468 | 0.025739 | 0.025964 | 0.026152 | 0.026309 |
| 732 | 0.024014 | 0.024398 | 0.024715 | 0.024977 | 0.025196 | 0.025378 | 0.025531 |
| 734 | 0.023496 | 0.023868 | 0.024176 | 0.024431 | 0.024642 | 0.024819 | 0.024968 |
| 736 | 0.022617 | 0.022978 | 0.023276 | 0.023523 | 0.023729 | 0.0239 | 0.024044 |
| 738 | 0.021756 | 0.022105 | 0.022393 | 0.022632 | 0.02283 | 0.022996 | 0.023135 |
| 740 | 0.021656 | 0.021996 | 0.022276 | 0.022509 | 0.022703 | 0.022864 | 0.023 |
| 742 | 0.020872 | 0.0212 | 0.021472 | 0.021697 | 0.021885 | 0.022041 | 0.022172 |
| 744 | 0.020328 | 0.020648 | 0.020912 | 0.021131 | 0.021313 | 0.021465 | 0.021593 |
| 746 | 0.019652 | 0.019962 | 0.020217 | 0.020429 | 0.020605 | 0.020752 | 0.020876 |
| 748 | 0.019457 | 0.019757 | 0.020005 | 0.02021 | 0.02038 | 0.020523 | 0.020642 |
| 750 | 0.019025 | 0.019315 | 0.019554 | 0.019752 | 0.019917 | 0.020055 | 0.02017 |
| 752 | 0.017942 | 0.018221 | 0.018452 | 0.018643 | 0.018801 | 0.018934 | 0.019045 |
| 754 | 0.017547 | 0.017818 | 0.018041 | 0.018227 | 0.018381 | 0.01851 | 0.018618 |
| 756 | 0.016903 | 0.017162 | 0.017376 | 0.017554 | 0.017702 | 0.017825 | 0.017929 |
| 758 | 0.01668 | 0.016933 | 0.017142 | 0.017315 | 0.017459 | 0.017579 | 0.01768 |
| 760 | 0.015836 | 0.016082 | 0.016284 | 0.016452 | 0.016592 | 0.016708 | 0.016806 |
| 762 | 0.015086 | 0.015324 | 0.015521 | 0.015684 | 0.01582 | 0.015933 | 0.016028 |
| 764 | 0.01462 | 0.014851 | 0.015043 | 0.015201 | 0.015333 | 0.015443 | 0.015536 |
| 766 | 0.014117 | 0.01434 | 0.014525 | 0.014678 | 0.014805 | 0.014912 | 0.015001 |
| 768 | 0.013729 | 0.013947 | 0.014127 | 0.014277 | 0.014401 | 0.014505 | 0.014591 |
| 770 | 0.013147 | 0.013357 | 0.01353 | 0.013674 | 0.013794 | 0.013893 | 0.013977 |
| 772 | 0.012958 | 0.013164 | 0.013335 | 0.013476 | 0.013593 | 0.013691 | 0.013774 |
| 774 | 0.012845 | 0.013048 | 0.013216 | 0.013355 | 0.013471 | 0.013567 | 0.013648 |
| 776 | 0.012681 | 0.012882 | 0.013047 | 0.013184 | 0.013298 | 0.013393 | 0.013473 |
| 778 | 0.012599 | 0.012798 | 0.012963 | 0.0131 | 0.013213 | 0.013308 | 0.013388 |
| 780 | 0.012726 | 0.012925 | 0.013089 | 0.013226 | 0.013339 | 0.013434 | 0.013513 |

TABLE VI
Chromaticity data and CRI for emission spectra shown in FIGS. 9 and 10.

| | CCT [K] | | | | | | |
|---|---|---|---|---|---|---|---|
| | 2726 | 2672 | 2631 | 2599 | 2574 | 2554 | 2538 |
| Ra | 75 | 74 | 73 | 73 | 72 | 72 | 72 |
| Δuv | 0.009 | 0.005 | 0.001 | 0.001 | 0.003 | 0.005 | 0.007 |
| x | 0.4418 | 0.4529 | 0.4623 | 0.4703 | 0.4771 | 0.4828 | 0.4876 |
| y | 0.3812 | 0.3946 | 0.406 | 0.4157 | 0.4239 | 0.4308 | 0.4366 |
| LE | 288 | 293 | 298 | 302 | 305 | 308 | 310 |
| MW | 593 | 596 | 599 | 601 | 603 | 604 | 606 |
| [nm] | | | | | | | |
| | T [μm] of the ceramic SiAlON garnet material | | | | | | |
| | 380 | 410 | 440 | 475 | 500 | 540 | 570 |
| R1 | 72.4 | 70.8 | 69.5 | 68.4 | 67.6 | 66.9 | 66.4 |
| R2 | 87.4 | 85.7 | 84.3 | 83.2 | 82.2 | 81.5 | 80.8 |
| R3 | 93.6 | 94.6 | 95.3 | 95.8 | 96.2 | 96.4 | 96.4 |
| R4 | 67.1 | 66.9 | 66.8 | 66.7 | 66.6 | 66.5 | 66.3 |
| R5 | 71.5 | 69.6 | 68.1 | 66.9 | 65.9 | 65 | 64.4 |
| R6 | 81.6 | 79.3 | 77.4 | 75.9 | 74.7 | 73.6 | 72.8 |
| R7 | 76.1 | 77 | 77.9 | 78.7 | 79.4 | 80.1 | 80.7 |
| R8 | 48.9 | 47.7 | 46.8 | 46.1 | 45.7 | 45.3 | 45 |
| R9 | −7.9 | −12.3 | −15.8 | −18.5 | −20.6 | −22.3 | −23.7 |
| R10 | 70.8 | 67.3 | 64.5 | 62.3 | 60.4 | 58.9 | 57.7 |
| R11 | 60.1 | 59.9 | 59.6 | 59.4 | 59.2 | 58.9 | 58.5 |
| R12 | 69.1 | 64.1 | 59.9 | 56.4 | 53.6 | 51.3 | 49.4 |
| R13 | 75.4 | 73.5 | 71.9 | 70.7 | 69.6 | 68.8 | 68.2 |
| R14 | 97.1 | 97.4 | 97.5 | 97.7 | 97.7 | 97.8 | 97.7 |

1. Light emitting device, especially a LED comprising a ceramic garnet material

2. The light emitting device of claim 1, whereby the ceramic garnet material contains nitrogen.

3. The light emitting device of claim 1, whereby the ceramic garnet material has pores which essentially have a diameter from ≧250 nm to ≦3500 nm.

4. The light emitting device of claim 1 whereby the pores of the ceramic garnet material have a log-norm-Distribution, which has a width of ≦100 nm.

5. The light emitting device of claim 1 whereby the ceramic garnet material has a density of 95% and ≦99.8 of the theoretical density.

6. The light emitting device of claim 1 whereby the ceramic garnet material comprises as a major constituent a material selected out of the group comprising (Y_{1-y}Gd_{y})₃₋ₓAl_{5-z}Si_{z}O_{12-z}N_{z}:Ceₓ with 0.002≦x≦0.03, 0≦y≦0.3 and 0.01≦z≦0.25, (Lu_{1-y}Y_{y})₃₋ₓAl_{5-z}Si_{z}O_{12-z}N_{z}:Ceₓ with 0.002≦x≦0.03, 0≦y≦1 and 0.01≦z≦0.5, (Lu_{1-y}Y_{y})₃₋ₓ₋ₐAl_{5-z}Si_{z}O_{12-z}N_{z}:CeₓSmₐ with 0.002≦x≦0.03, 0≦y≦1, 0.01≦z≦0.5, and 0.001≦a≦0.03, (Lu_{1-y}Y_{y})₃₋ₓ₋ₐAl_{5-z}Si_{z}O_{12-z}:CeₓPrₐ with 0.002≦x≦0.03, 0≦y≦1, 0.01≦z≦0.5, and 0.001≦a≦0.03 or mixtures thereof.

7. The light emitting device of claim 1 whereby the amount of glass phase of the ceramic garnet material is ≧0.002 (vol-) % to ≦1 (vol-) %.

8. A method of producing a ceramic garnet material for a light emitting device according to claim 1 comprising a sintering step.

9. A method of obtaining a light emitting device according to claim 1 with a desired color temperature and/or adjusting a light emitting according to claim 1 to a desired color temperature comprising the steps of
Producing a ceramic garnet material according to claim 1, comprising a sintering step
Measuring the pore size, distribution and concentration in the ceramic garnet material
Deriving the required thickness of the ceramic garnet material for obtaining a light emitting device with the desired color temperature and distance to the white color point of the reference light source with that CCT
optionally reducing the thickness and/or the pore size, distribution and/or concentration to adjust the light emitting device using the ceramic garnet material to the desired color temperature

10. A system comprising a light emitting device according to claim 1, the system being used in one or more of the following applications:
Office lighting systems
household application systems
shop lighting systems,
home lighting systems,
accent lighting systems,
spot lighting systems,
theater lighting systems,
fiber-optics application systems,
projection systems,
self-lit display systems,
pixelated display systems,
segmented display systems,
warning sign systems,
medical lighting application systems,
indicator sign systems, and
decorative lighting systems
portable systems
automotive applications
green house lighting systems
